(19) United States
(12) Patent Application Publication
(10) Pub. No.: US 2026/0335839 A1
(43) Pub. Date: Oct. 29, 2026

(54) METAL ORGANIC FRAMEWORK MODIFIED GRAPHENE OXIDE MEMBRANES

(71) Applicant: Via Separations, Inc., Watertown, MA (US)

(72) Inventor: Stephen FRAYNE, Wayland, MA (US)

(21) Appl. No.: 19/704,692

(22) Filed: Jun. 11, 2026

Related U.S. Application Data
(63) Continuation of application No. PCT/US2024/051111, filed on Oct. 11, 2024.
(60) Provisional application No. 63/610,980, filed on Dec. 15, 2023.

(51) Int. Cl. B01D 71/02; B01D 67/00; B01D 69/10; B01D 69/14; B01D 71/06

(52) U.S. Cl. CPC B01D 71/0211; B01D 67/00793; B01D 69/107; B01D 69/148; B01D 71/06; B01D 2323/081

(57) ABSTRACT

Filtration apparatus comprising Graphene Oxide (GO) membranes modified by incorporation of metal organic frameworks (MOFs) are described herein. The GO membranes include graphene oxide sheets coupled to a metal organic framework. Incorporation of MOFs into GO can alter the distance between the layers of the GO, affecting the transport and screening of specific molecules, thereby resulting in improved filtration apparatus performance with respect to prior art membranes (e.g., high flux and rejection rate). The filtration apparatus described herein can exhibit improved performance in applications such as pulp and paper processing, which facilitates achieving permeate quality targets.

### CROSS-REFERENCE TO RELATED APPLICATIONS

This application is a continuation of International Patent Application No. PCT/US2024/051111, entitled “Metal Organic Framework Modified Graphene Oxide Membranes,” filed Oct. 11, 2024, which claims priority to and the benefit of U.S. Provisional Patent Application 63/610,980, entitled “Metal Organic Framework Modified Graphene Oxide Membranes,” filed Dec. 15, 2023, the disclosure of each of which is incorporated by reference herein in its entirety.

### GOVERNMENT SUPPORT

This invention was made with U.S. government support under Grant No. DE-AR0001686 awarded by the Department of Energy. The U.S. government has certain rights in the invention.

### TECHNICAL FIELD

The present disclosure relates generally to graphene oxide membranes including metal organic frameworks (MOFs) and their use in separation processes.

### BACKGROUND

Membranes serve as a selective barrier in the separation process, allowing certain components (filtrate or permeate) to pass through while preferentially retaining others (rejects). This separation is based on various properties of the membrane and the components being filtered. For instance, membranes can be designed to separate rejects from a filtrate based on size exclusion, where the membrane acts as a physical barrier with pores smaller than the particles to be excluded. Other examples include membranes that are configured to separate rejects from a filtrate based on chemical, electrochemical, and/or physical interactions with one or more components of the material being filtered.

Polymer membranes are a common type of membrane. They have been used commercially in a wide range of applications including water softening, desalination, and for the concentration, removal, and purification of different salts, small molecules, and macromolecules. However, in certain environments (e.g., oxidizing conditions, high pH, high temperatures, or in some solvents), polymer membranes can become damaged or fail due to swelling, oxidation reactions, degradation, or softening of the polymer. Graphene oxide (GO) membranes are a relatively new type of membrane prepared and/or fabricated using an oxidized form of graphene, a material recognized for its superior mechanical properties and chemical stability. While GO membranes hold a lot of promise, there remains a challenge to chemically engineer a GO membrane to achieve the desired filtration characteristics such as high conductivity rejection, and high flux. Accordingly, there is a need in the art for new membranes that address one or more deficiencies of the membranes in the prior art.

### SUMMARY

Embodiments described herein relate generally to durable graphene oxide membranes for fluid filtration. For example, the graphene oxide membranes can be used for concentration, removal, and purification of organic species and other solids included in weak black liquor streams.

In some embodiments, described herein is a filtration apparatus including a support substrate; and a metal organic framework modified graphene oxide (MOF-GO) membrane disposed on the support substrate. The MOF-GO includes: a plurality of graphene oxide sheets; and a metal organic framework intercalated between the plurality of graphene oxide sheets, wherein the MOF-GO membrane has a total solids rejection rate of at least about 50% and a flux of at least about 4 gallons per square foot per day (GFD) in flowing a weak black liquor solution at a predetermined temperature and pressure.

In some embodiments, the flowing weak black liquor solution comprises sodium sulfate, sodium carbonate, sodium hydrosulfide, sodium thiosulfate, sodium hydroxide, tall oils, carbohydrates, lignin, cellulose, hemicellulose, or a combination thereof

In some embodiments, the weak black liquor solution contains between about 2 and 20 wt. % total dissolved solids.

In some embodiments, the predetermined temperature is at least about 50 °C.

In some embodiments, a mass ratio of the metal organic framework to the plurality of graphene oxide sheets is from about 1:1 to about 1:4.

In some embodiments, the metal organic framework includes: a coordinated metal; and an organic linker covalently bound to the coordinated metal.

In some embodiments, the coordinated metal is selected from at least one of Cu, Co, or Ni.

In some embodiments, the organic linker selected from at least one of hexahydroxytriphenylene, 1,3,5-benzenetricarboxylic acid or a derivative thereof.

In some embodiments, the metal organic framework includes Cu—H₃BTC.

In some embodiments a method for fabricating a filtration apparatus includes: preparing a graphene oxide dispersion that includes a predetermined concentration of graphene oxide sheets. The method further includes mixing a metal-containing reagent to the graphene oxide dispersion; mixing an organic linker to the graphene oxide dispersion; after mixing the metal containing reagent and the organic linker, stirring the graphene oxide dispersion at a predetermined temperature for a period of time to produce a metal organic framework graphene oxide (MOF-GO) slurry; and coating the MOF-GO slurry on a support substrate.

In some embodiments, the metal-containing reagent is a coordinated metal selected from at least one of Cu, Co, or Ni.

In some embodiments, the organic linker is selected from at least one of hexahydroxytriphenylene, 1,3,5-benzenetricarboxylic acid or a derivative thereof.

In some embodiments, the MOF-GO slurry includes Co—H₃BTC.

In some embodiments, the predetermined temperature is at least about 60 °C and the less than about 90 °C.

In some embodiments, mixing an organic linker to the graphene oxide dispersion further includes: mixing the organic linker with a solvent at a dissolving temperature; heating the solvent with the organic linker to a solubilization temperature to produce an organic linker solution; and adding the organic linker solution to the graphene oxide dispersion.

In some embodiments, the organic linker is 1,3,5-benzenetricarboxylic acid, the solvent is one of isopropyl alcohol or ethanol, and the dissolving temperature is about 60 °C.

In some embodiments, the predetermined concentration of graphene oxide sheets is at least about 0.2 wt. % and no more than about 0.4 wt. %.

In some embodiments, the support substrate includes at least one of polystyrene, polyethylene, polyethylene oxide, polyethersulfone (PES), o polytetrafluoroethylene.

### BRIEF DESCRIPTION OF THE DRAWINGS

FIG. 1 is a schematic illustration of a filtration apparatus 1000, according to an embodiment.

FIG. 2 is a schematic illustration of a metal organic framework modified graphene oxide (MOF-GO) membrane, according to an embodiment.

FIGS. 3A-3C show crossflow test results of a filtration apparatus including various exemplary MOF-GO membranes fabricated according to an embodiment.

FIG. 4 shows a graph displaying flux (in gallons per square foot per day, or GFD) and feed total dissolved solids (TDS) of exemplary MOF-GO membranes prepared and/or produced according to an embodiment of the present disclosure.

FIG. 5 shows a graph displaying permeate total dissolved solids (TDS) and feed TDS of exemplary MOF-GO membranes prepared and/or produced according to various embodiments of the present disclosure.

FIG. 6 shows a graph displaying flux (in gallons per square foot per day, or GFD) and feed total dissolved solids (TDS) of exemplary MOF-GO membranes prepared and/or produced according to an embodiment of the present disclosure.

FIG. 7 shows a graph displaying permeate total dissolved solids (TDS) and feed TDS of exemplary MOF-GO membranes prepared and/or produced according to an embodiment of the present disclosure

FIG. 8 shows a chemical reaction between cobalt acetate-tetrahydrate (Co(CH₃CO₂)₂·4H₂O) and 2,3,6,7,10,11 hexahydroxytriphenylene (HHTP) to produce a cobalt metal organic framework (Co-HHTP MOF), according to an embodiment

FIG. 9 shows example thermogravimetric analysis (TGA) curves of 2,3,6,7,10,11 hexahydroxytriphenylene (HHTP), cobalt acetate tetrahydrate, and a cobalt metal organic framework modified graphene oxide Co-HHTP/GO membrane prepared and/or produced according to an embodiment of the present disclosure.

FIGS. 10A-10B show scanning electron microscopy (SEM) images and corresponding Energy Dispersive Spectroscopy (EDS) graphs recorded on the surface of a filtration apparatus including a Ni-HHTP/-GO membrane prepared and/or produced according to an embodiment of the present disclosure.

FIGS. 11A-11B display Scanning Electron Microscopy (SEM) images and corresponding Energy Dispersive Spectroscopy (EDS) graphs, taken from the surface of a filtration apparatus including a Co-HHTP/GO membrane prepared and/or produced according to an embodiment of the present disclosure.

### DETAILED DESCRIPTION

Graphite is a crystalline form of carbon with its atoms arranged in a hexagonal structure layered in a series of planes. Due to its abundance on earth, graphite is low-cost and is commonly used in pencils and lubricants. Graphene is a single, one atomic layer of carbon atoms (i.e., one of the layers of graphite) with several exceptional electrical, mechanical, optical, and electrochemical properties, earning it the nickname “the wonder material.” To name just a few, it is highly transparent, extremely light and flexible yet robust, and an excellent electrical and thermal conductor. Such extraordinary properties render graphene and related thinned graphite materials (e.g., few layer graphene) as promising candidates for a diverse set of applications. For example, graphene can be used in coatings to prevent steel and aluminum from oxidizing, and to filter salt, heavy metals, and oil from water.

Graphene oxide is an oxidized form of graphene having oxygen-containing pendant functional groups (e.g., epoxide, carboxylic acid, or hydroxyl) that exist in the form of single atom thick sheets. By oxidizing the graphene in graphite, graphene oxide sheets can be produced. For example, the graphene oxide sheets can be prepared from graphite using a modified Hummers method. Flake graphite is oxidized in a mixture of KMnO₄, H₂SO₄, and/or NaNO₃, then the resulting pasty graphene oxide was diluted and washed through cycles of filtration, centrifugation, and resuspension. The washed graphene oxide suspension is subsequently ultrasonicated to exfoliate graphene oxide particles into graphene oxide sheets and centrifuged at high speed to remove unexfoliated graphite residues. The resulting yellowish/light brown solution is the final graphene oxide sheet suspension. This color indicates that the carbon lattice structure is distorted by the added oxygenated functional groups. The produced graphene oxide sheets are hydrophilic and can stay suspended in water for months without a sign of aggregation or deposition.

Due in part for its low cost, high chemical stability, strong hydrophilicity, and compatibility with a variety of environments, graphene oxide has been explored for its use as membranes in filtration applications. For example, as compared to polymer membranes (e.g., membranes made entirely of a polymeric material), which can be prone to oxidation, graphene oxide membranes can remain stable under oxidizing conditions. Graphene oxide (GO) membranes can also be formed into stacked layers by orienting a large majority of the graphene oxide sheets parallel to each other. The distance between stack layers, also referred to as the interlayer spacing and/or d-spacing, tends to be relatively small, which provides graphene oxide membranes a controlled molecular weight cutoff. Furthermore, in some instances, the d-spacing of graphene oxide membranes can be fine-tuned via chemical and/or physical treatments, resulting in high rejection rates suitable for multiple filtration applications.

Despite these advantages, the performance of existing GO membranes can be negatively impacted by a number of deficiencies. For example, GO membranes can experience limited and/or reduced durability when exposed to high temperatures or acidic/basic conditions. Some existing graphene oxide membranes can achieve high rejection rates when used in reverse osmosis applications at room temperature. However, after exposure to high temperatures (e.g., greater than about 50 °C) and/or highly alkaline pH environments (e.g., pH=11) for a period of time the performance of these graphene oxide membranes diminishes. Existing GO membranes can also suffer from small and/or reduced flux, which limits and, in some instances, precludes their use in filtration applications that involve large flowrates and/or large volumes. Without being bound by any particular theory, it is believed that the relatively small d-spacing of stacked layers in GO membranes leads to controlled molecular weight cutoff and high rejection rates for a wide range of species of interest in filtration applications. However, that small d-spacing can also translate into small flux and/or high pressure drop during filtration operations.

Metal-Organic Frameworks (MOFs) represent a class of materials characterized by a distinct architecture formed through the coordination of metal ions or clusters, known as metal nodes, with organic linker molecules. These organic linkers, featuring functional groups capable of coordinating with metal nodes, establish a network of coordination bonds, resulting in a crystalline and highly porous three-dimensional framework. The porous structure, akin to a molecular sponge, provides MOFs with unique properties and applications. The choice of metal nodes and organic linkers allows for precise tuning of the framework's properties, including pore size, surface area, and chemical reactivity. MOFs exhibit versatility, finding applications in diverse fields such as gas storage, separation, catalysis, and drug delivery, making them an area of active research and development.

Incorporating highly ordered metal organic frameworks (MOFs) into GO membranes may offer various benefits. For example, incorporation of one or more MOFs in between the graphene oxide sheets that form a GO membrane may change and/or modify the packing of the graphene oxide sheets, adjusting the interlayer distance (d-spacing) of the GO membrane and influencing the transport and screening of specific molecules. By intercalating selected MOFs in between the graphene oxide sheets, metal organic framework modified graphene oxide (MOF-GO) membranes having increased d-spacing can be prepared. These MOF-GO membranes can retain the key properties of conventional graphene oxide membranes including the stability under high temperatures and/or highly alkaline pH environments, chemical affinity, and high rejection rates, while exhibiting a significantly improved flux owing to their increased d-spacing. Incorporation of MOFs into GO membrane may also provide an approach to adjust and/or modify (e.g., increase or decrease) the tortuosity of the pathway(s) within the GO membrane for diffusion of species. Increasing the tortuosity of the GO membrane by incorporation of MOFs may increase the rejection rate and decrease the flux of the GO membrane. Conversely, decreasing the tortuosity of the GO membrane by incorporation of MOFs may decrease the rejection rate and increase the flux of the GO membrane. The introduction of MOFs into the GO membranes can also increase the porosity and mechanical stability of the GO membranes. Thus, a filtration apparatus that includes GO membranes including MOFs may exhibit high flux and high rejection rates for a wide variety of filtration applications. The present disclosure provides filtration systems and GO membranes that address the limitations of current GO membranes and exhibit one or more superior properties over existing GO membranes by incorporating metal organic frameworks (MOFs) producing metal organic framework modified graphene oxide MOF-GO membranes.

### Filtration Apparatus

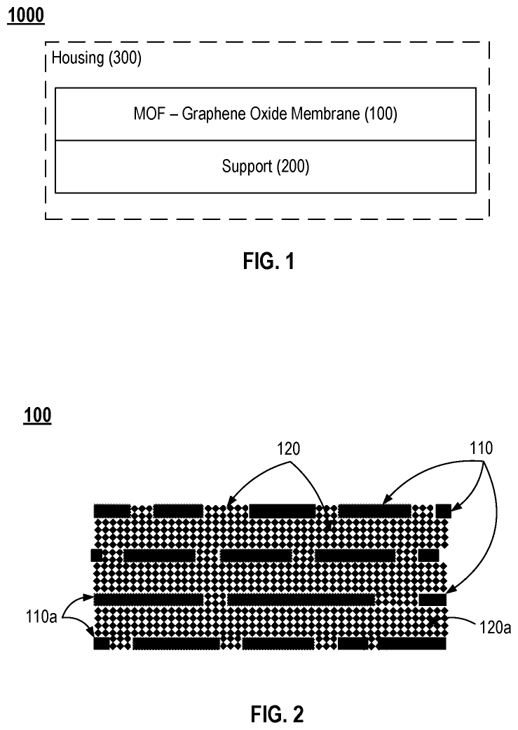

FIG. 1 shows a schematic illustration of a filtration apparatus 1000 according to the present disclosure. The filtration apparatus 1000 includes a metal organic framework modified graphene oxide (MOF-GO) membrane 100, a support 200, and optionally a housing 300. The MOF-GO membrane 100 can be disposed on the support 200, and the optional housing 300 can enclose the support 200 and the MOF-GO membrane 100.

In some embodiments, the MOF-GO membrane 100 and the support 200 can have a combined thickness of about 50 μm to about 1300 μm, (e.g., about 50 μm, about 60 μm, about 80 μm, about 100 μm, about 150 μm, about 200 μm, about 250 μm, about 300 μm, about 350 μm, about 400 μm, about 450 μm, about 500 μm, about 550 μm, about 600 μm, about 650 μm, about 700 μm, about 750 μm, about 800 μm, about 850 μm, about 900 μm, about 950 μm, about 1000 μm, about 1100 μm, about 1200 μm, or about 1300 μm, including any values and subranges in between.) For example, in some embodiments the MOF-GO membrane 100 and the support 200 can have a combined thickness of about 100 μm to about 750 μm, about 200 μm to about 1000 μm, or about 200 μm to about 1200 μm, inclusive of all values and ranges therebetween.

In some embodiments, the filtration apparatus 1000 can comprise a plurality of flat polymer sheets combined to form a spiral filtration module. Each flat polymer sheet can comprise a support 200 and an MOG-GO membrane 100 coated on the support 200. For example, in some embodiments, a spiral filtration module can comprise a plurality of flat polymer sheets stacked atop one another, and the plurality of stacked flat polymer sheets may be rolled around a core tube. In some embodiments, prior to being rolled around the core tube, adjacent flat polymer sheets may be separated by a sheet of feed channel spacer to form a leaf, and each leaf may be separated by a sheet of permeate spacer. When the flat polymer sheets, the one or more feed channel spacers, and the one or more permeate spacers are rolled around the core tube, each permeate spacer may form a permeate channel.

In some embodiments, the filtration apparatus 1000 includes about 0.1 mg to 6 mg of the MOF-GO membrane 100 per 5000 mm². In some embodiments, the filtration apparatus 1000 includes about 0.1 mg to 5 mg, about 0.1 mg to 4 mg, about 0.1 mg to 3 mg, about 0.5 mg to 5 mg, about 0.5 mg to 4 mg, about 0.5 mg to 3 mg, about 1 mg to 4 mg, or about 1 mg to 3 mg of the MOF-GO membrane 100 per 5000 mm². For example, the filtration apparatus 1000 can include about 1 mg, about 1.5 mg, about 2 mg, about 2.5 mg, or about 3 mg of the MOF-GO membrane 100 per 5000 mm².

FIG. 2 presents a schematic diagram of the structure of the MOF-GO membrane 100 shown in FIG. 1. The MOF-GO membrane 100 includes a plurality of graphene oxide (GO) sheets 110 and one or more MOF(s) 120. The GO sheets 110 can be arranged and/or oriented generally parallel to each other forming one or more stacked layers. The spacing (e.g., d-spacing) between GO sheets 110 can be either interlayer spacing or intralayer spacing. The spacing between the GO sheet 110 can be engineered to control the molecular weight cutoff and the flux properties of the MOF-GO membrane 100, as further described herein. As shown in FIG. 2, the one or more MOF(s) 120 can be disposed between adjacent stacked layers of GO sheets 110. That is to say, the one or more MOF(s) can be intercalated between stacked GO sheets 110 adjusting the spacing between GO sheets 110 and/or modifying the tortuosity of the diffusion pathway(s) within the GO membrane for transport of species.

In some embodiments, the MOF-GO membrane 100 can have a thickness greater than or equal to about 25 nm, greater than or equal to about 50 nm, greater than or equal to about 0.1 microns, greater than or equal to about 0.15 microns, greater than or equal to about 0.2 microns, greater than or equal to about 0.3 microns, greater than or equal to about 0.4 microns, greater than or equal to about 0.5 microns, greater man or equal to about 0.75 microns, greater than or equal to about 1 micron, or greater than or equal to about 2 microns. In some embodiments, the thickness of the MOF-GO membrane 100 may be less than or equal to about 5 microns, less than or equal to about 1 micron, less than or equal to about 0.75 microns, less than or equal to about 0.5 microns.

Combinations of the above-referenced ranges for the thickness of the MOF-GO membrane 100 are also possible (e.g., greater than or equal to about 25 nm to less than or equal to about 5 microns, greater than or equal to about 0.15 microns to less than or equal to about 0.6 microns).

In some embodiments, the MOF-GO membrane 100 can include pores having an average pore size of greater than or equal to about 0.5 nm, greater than or equal to about 1 nm, greater than or equal to about 2 nm, greater than or equal to about 3 nm, greater than or equal to about 4 nm, or greater than or equal to about 5 nm. In some embodiments, the MOF-GO membrane 100 can include pores having an average pore size of less than or equal to about 6 nm, less than or equal to about 5 nm, less than or equal to about 4 nm, less than or equal to about 3 nm, or less than or equal to about 2 nm, inclusive of all values and ranges therebetween.

Combinations of the above-referenced ranges for the average pore size are also possible (e.g., greater than or equal to about 0.5 nm to less than or equal to about 6 nm, greater than or equal to about 1 nm to less than or equal to about 6 nm). In some embodiments, the MOF-GO membrane 100 can include pores having an average pore size of about 0.5 nm, about 0.8 nm, about 1 nm, about 2 nm, about 3 nm, about 4 nm, about 5 nm, or about 6 nm.

Alternatively, and/or additionally, in some embodiments the MOF-GO membrane 100 can have multi-modal pore size distribution (i.e., having more than one distinct mode or peak in its size distribution curve).

The GO sheets 110 can include flakes. The flakes can have an aspect ratio (on the plane of the GO sheets 110). In some embodiments, the aspect ratio can be less than about 250,000:1, less than about 100,000:1, less than about 50,000:1, less than about 25,000:1, less than about 10,000:1, less than about 5,000:1, less than about 1,000:1. In some embodiment, the flakes can have an aspect ratio of at least about 100:1, at least about 200:1, at least about 300:1, at least about 400:1, or at least about 500:1, inclusive of all values and ranges therebetween.

In some embodiments, the GO sheets 110 can have a carbon to oxygen ratio (C:O) of at least about 1.0:1, at least about 1.1:1, at least about 1.2:1, at least about 1.3:1, at least about 1.4:1, at least about 1.5:1, at least about 1.6:1, at least about 1.7:1, at least about 1.8:1, at least about 1.9:1, at least about 2.0:1, at least about 2.2:1, at least about 2.4:1, at least about 2.6:1, at least about 2.8:1, or at least about 3.0:1, inclusive of all values and ranges therebetween.

In some embodiments, the MOF-GO membrane 100 can include at least about 100 layers of GO sheets 110, at least about 125 layers, at least about 150 layers, at least about 200 layers, at least about 225 layers, at least about 250 layers of GO sheets 110, inclusive of all values and ranges therebetween. In some embodiments, the MOF-GO membrane 100 can include no more than about 600 layers of GO sheets 110, no more than about 550 layers, no more than about 500 layers, no more than about 450 layers, no more than about 400 layers, no more than about 350 layers, or no more than about 300 layers, inclusive of all values and ranges therebetween.

Combinations of the above-referenced ranges for the number of layers of GO sheets 110 in the MOF-GO membrane 100 are also possible (e.g., at least about 100 to less than about 600, or at least about 300 to less than about 600), inclusive of all values and ranges therebetween.

In some embodiments, the MOF-GO membrane 100 can include about 100 to 600 layers of GO sheets 110, e.g., 200-500 layers, 200-400 layers, 200-300 layers, 200-250 layers, 300-600 layers, 300-500 layers, or 300-400 layers.

As described above with reference to FIG. 2, in some embodiments the GO sheets 110 can be coupled to one or more MOF(s) 120 via one or more chemical and/or physical interactions. For example, in some embodiments, the GO sheets 110 can be coupled to the MOF(s) 120 via chemical interactions, and/or chemical reactions that form covalent bonds (e.g., covalent interactions). For example, in some embodiments, metal centers in the MOF(s) 120 may form coordination bonds with oxygen-containing functional groups on the GO sheets 110 such as epoxide groups, carboxylic groups, or hydroxyl groups. In such embodiments, the structure of the MOF-GO membrane 100 can be such that the GO sheets 110 form one or more coordination bonds attaching the GO sheets 110 to the MOF(s) 120. Alternatively, in some embodiments the GO sheets 110 can be coupled to the MOF(s) 120 via physical and/or noncovalent interactions. For example, in some embodiments the MOF(s) 120 can be coupled to one or more GO sheets 110 through ionic interactions (i.e., electrostatically). In some embodiments, the MOF(s) 120 can be coupled to one or more GO sheets 110 through hydrogen bonding. In some embodiments, the MOF(s) 120 can be coupled to the GO sheets 110 through one or more Van der Waals forces. In some embodiments, the MOF(s) 120 can be coupled to the GO sheets 110 through one or more π-effects. In some embodiments, the MOF(s) 120 can be coupled to the GO sheets 110 through the hydrophobic effect. In some embodiments, the GO sheets 110 can be coupled to the MOF(s) 120 via covalent interactions and physical and/or noncovalent interactions (e.g., a combination of covalent interactions and non-covalent interactions). The coupling of the MOF(s) 120 and the GO sheets 110 via covalent and/or non-covalent interactions can result in the formation of a MOF-GO membrane 100 in which the MOF(s) 120 are disposed intercalated between GO sheets 110. For example, as shown in FIG. 2, two adjacent GO sheets 110a can be coupled to one or more MOF(s) 120a such that the MOF(s) 120a are disposed intercalated between the two adjacent GO sheets 110a.

As described above, metal-organic frameworks (MOFs) represent a class of materials characterized by a distinct architecture formed through the coordination of metal ions or clusters, known as metal nodes, with organic linker molecules. These organic linkers, featuring functional groups capable of generating coordinate bonds (also referred to as dative covalent bonds) with metal nodes, establish a network of coordination bonds, resulting in a crystalline and highly porous framework. The metal organic frameworks MOF(s) 120 can form one dimensional, two-dimensional, or three-dimensional structures. In some embodiments, the MOF(s) 120 may be produced in the form of continuous phase. In some embodiments, the MOF(s) 120 may be in the form of flakes and/or particles.

In some embodiments, a mass ratio of the MOF(s) 120 to the GO sheets 110 in the MOF-GO membrane 100 can be at least about 1:1, at least about 1:1.2, at least about 1:1.4, at least about 1:1.6, at least about 1:1.8, at least about 1:2.0, at least about 1:2.2, at least about 1:2.4, at least about 1:2.6, at least about 1:2.8, at least about 1:3.0, at least about 1:3.2, at least about 1:3.4, at least about 1:3.6, at least about 1:3.8, at least about 1:4.0, at least about 1:4.2, at least about 1:4.4, at least about 1:4.6, at least about 1:4.8, at least about 1:5.0, at least about 1:5.2, at least about 1:5.4, at least about 1:5.6, at least about 1:5.8, at least about 1:6.0, at least about 1:7.0, at least about 1:8.0, at least about 1:9.0, at least about 1:10.0, at least about 1:11.0, or at least about 1:12.0, inclusive of all values and ranges therebetween. In some embodiments, a mass ratio of the MOF(s) 120 to the GO sheets 110 can be no more than about 1:12.0, no more than about 1:10.0, no more than about 1:8.0, no more than about 1:6.0, no more than about 1:4.0, no more than about 1:2.0, or no more than about 1:1.0.

The MOF(s) 120 include metal nodes (i.e., coordinated metals) and organic linkers having functional groups capable of coordinating with metal node to establish a network of coordination bonds (i.e., MOF). In some embodiments, the MOF(s) 120 may include a one or more metal node(s) including a metal selected from one or more transition metal cations, such as one or more of Cr(+3), Fe(+2), Fe(+3), Al(+3), Co(+2), Ru(+3), Os(+3), Hf(+4), Ni, Mn, V, Sc, Y(lll), Cu(ll), Cu(+1), Zn(+2), Zr(+4), Cd, Pb, Ba, Ag(+1), Au, AuPd, Ni/Co, lanthanides, actinides, such as Lu, Tb(+3), Dy(+3), Ho(+3), Er(+3), Yb(+3). In some embodiments, the metal node(s) can preferably include a metal selected from Cr(+3), Fe(+2), Fe(+3), Al(+3), Co(+2), Ru(+3), Os(+3), Hf(+4), Ni, Mn, V, Sc, Y(+3), Cu(+2), Cu(+1), Zn(+2), Zr(+4), Cd, Pb, Ba, Ag(+1), Ni/Co, lanthanides, actinides, such as Lu, Tb(+3), Dy(+3), Ho(+3), Er(+3), Yb(+3).

The organic linkers of the MOF(s) 120 may be formed from a wide range of organic molecules, such as one or more carboxylate linkers; N-heterocyclic linkers; phosphonate linkers; sulphonate linkers, metallo linkers, such a carboxylate-metallo linkers; and mixtures and derivatives thereof. In some embodiments, the organic linkers may comprise one or more of ditopic, tritopic, tetratopic, hexatopic, octatopic linkers. In some embodiments, the organic linkers may comprise desymmetrised linkers.

In some embodiments, the organic linker may be selected from at least one of 2,3,6,7,10,11 hexahydroxytriphenylene (HHTP), 1,3,5-benzenetricarboxylic acid or a derivative thereof. In some embodiments, the organic linker includes hexahydroxytriphenylene or a derivative thereof. In some embodiments, the organic linker includes 1,3,5-benzenetricarboxylic acid (H₃BTC, also referred to as trimesic acid) or a derivative thereof.

In some embodiments, the MOF(s) 120 may include a metal atom or a metal ion selected from at least one of Cu, Co, or Ni.

In some embodiments, the MOF(s) 120 may have high surface area and/or large pore sizes. The surface area can be measured using the known Brunauer, Emmett and Teller (BET surface area) technique. As used herein, the pore sizes of MOF(s) 120 refer to the dimensions of the empty spaces, cavities, and/or channels present within the MOF(s) 120 structure (e.g., within a 3-D MOF structure). The size and shape of these pores can be tuned by varying the metal ions, organic linkers, and synthetic conditions used to create the MOF(s) 120. In some embodiments, the pore size of the MOF(s) 120 may be tailored by using different chemical species during the synthesis and/or fabrication of the MOF(s) 120 (e.g., different organic linkers, and/or metals). In some embodiments, the pore size of the MOF(s) 120 may be tailored by controlling one or more conditions employed during the synthesis and/or fabrication of the MOF(s) 120 (e.g., temperature, pressure, pH, agitation, etc.) The average pore size of MOF(s) 120 can be determined by calculation the pore size distribution using Nitrogen adsorption data. In some embodiments, a maximum and/or a limit pore size can also be estimated from crystallographic data by simulating pore filling with gas molecules which allow the calculation of the average pore sizes.

In some embodiments, the MOF(s) 120 may have an average pore size of from about 0.1 nm to about 100 nm, about 0.2 nm to about 100 nm, about 0.2 nm to about 90 nm, about 0.3 nm to about 75 nm, about 0.4 nm to about 50 nm, 0.4 nm to about 40 nm, about 0.4 nm to about 30 nm, or about 0.4 nm to about 20 nm, inclusive of all values and ranges therebetween.

In some embodiments, the MOF(s) 120 can have a pore volume of at least about 0.2 cm³/g or more, at least about 0.3 cm³/g, at least about 0.4 cm³/g, at least about 0.5 cm³/g, at least about 0.6 cm³/g, at least about 0.7 cm³/g, at least about 0.8 cm³/g, at least about 0.9 cm³/g, at least about 1 cm³/g, at least about 1.1 cm³/g, at least about 1.2 cm³/g, at least about 1.3 cm³/g, at least about 1.4 cm³/g, at least about 1.5 cm³/g, about 2.0 cm³/g, or about 2.5 cm³/g, inclusive of all values and ranges therebetween. In some embodiments, the MOF(s) 120 can have a pore volume of no more than about 2.5 cm³/g, no more than about 2.0 cm³/g, no more than about 1.5 cm³/g, no more than about 1.4 cm³/g, no more than about 1.3 cm³/g, no more than about 1.2 cm³/g, no more than about 1.1 cm³/g, no more than about 1 cm³/g, no more than about 0.9 cm³/g, no more than about 0.8 cm³/g, no more than about 0.7 cm³/g, no more than about 0.6 cm³/g, no more than about 0.5 cm³/g, no more than about 0.4 cm³/g, or no more than about 0.3 cm³/g, inclusive of all value sand ranges therebetween.

Combinations of the above-referenced ranges for the pore volume of the MOF(s) 120 are also possible (e.g., at least about 0.2 cm³/g to less than about 1.5 cm³/g, or at least about 0.3 cm³/g to less than about 1.4 cm³/g), inclusive of all values and ranges therebetween.

In some embodiments, the MOF(s) 120 can have a BET surface area of at least about 20 m²/g or more, at least about 40 m²/g, at least about 80 m²/g, at least about 100 m²/g, at least about 250 m²/g, at least about 500 m²/g, at least about 750 m²/g, at least about 1000 m²/g, at least about 2000 m²/g, at least about 3000 m²/g, at least about 4000 m²/g, at least about 5000 m²/g, at least about 6000 m²/g, at least about 7000 m²/g, at least about 8000 m²/g, at least about 9000 m²/g, or at least about 10000 m²/g, inclusive of all values and ranges therebetween. In some embodiments, the MOF(s) 120 can have a BET surface area of no more than about 10000 m²/g, no more than about 7500 m²/g, no more than about 5000 m²/g, no more than about 2500 m²/g, no more than about 1000 m²/g, no more than about 800 m²/g, no more than about 600 m²/g, no more than about 400 m²/g, no more than about 200 m²/g, no more than about 100 m²/g, no more than about 50 m²/g, no more than about 40 m²/g, no more than about 35 m²/g, or no more than about 20 m²/g, inclusive of all values and ranges therebetween.

Combinations of the above-referenced ranges for the BET surface area of the MOF(s) 120 are also possible (e.g., at least about 150 cm³/g to less than about 3000 cm³/g, or at least about 1000 cm³/g to less than about 9000 cm³/g), inclusive of all values and ranges therebetween.

In some embodiments, the MOF(s) 120 may comprise one or more functional groups. For example, in some embodiments, the MOF(s) 120 may include surface functional groups adapted for water treatment, molecule separation, and biofiltration related applications. In some embodiments, the surface functional groups can be incorporated by use of organic linkers having chemical functionalities such as hydroxyl (OH⁻), carboxylic acid (COOH), acetate (COO⁻), or the like. The functional groups may provide selectivity for the transport and/or adsorption capacity selected species, leading to improved flux and/or rejection rates.

As described above with reference to FIG. 1, the filtration apparatus 1000 includes a support 200. The support 200 can be a substrate material that provides a surface on which the MOF-GO membrane 100 can be disposed. The support 200 can act as a protective layer that prevents damage of the MOF-GO membrane 100 and other components of the filtration apparatus 1000. For example, the support 200 can protect the MOF-GO membrane 100 from damage (e.g., formation of pinholes, punctures, cracks, or other mechanical stress-induce defects) resulting from the fabrication of spiral membranes, and/or the use of the filtration apparatus 1000 under harsh environment conditions (high pressure, highly alkaline conditions, extended periods of time, etc.).

The support 200 may include any porous material operable to support the MOF-GO membrane 100 during the filtration process. In some embodiments, the support 200 could offer a blend of affordability, ease of manufacture, and robust mechanical strength. The support 200 may include one layer or multiple layers.

In some embodiments, the support 200 can include a non-woven fiber or polymer. In some embodiments, the support 200 can include a material selected from polypropylene (PP), polystyrene, polyethylene, polyethylene oxide, polyethersulfone (PES), polytetrafluoroethylene, polyvinylidene fluoride, polymethylmethacrylate, polydimethylsiloxane, polyester, cellulose, cellulose acetate, cellulose nitrate, polyacrylonitrile, glass fiber, quartz, alumina, silver, polycarbonate, nylon, Kevlar or other aramid, or polyether ether ketone.

In some embodiments, the support 200 is a porous substrate. The support 200 layer may have any suitable pore size. The support 200 can have an average pore size of 2 nm to 20 nm, e.g., 2 nm to 15 nm, 4 m to 12 nm, 8 nm to 10 nm, or 8 nm to 20 nm. In some embodiments, the support 200 can have an average pore size less than 20 nm, such as about 2 nm, about 4 nm, about 6 nm, about 8 nm, about 10 nm, about 12 nm, about 14 nm, about 16 nm, or about 18 nm.

In some embodiments, the support 200 can include two or more layers. For example, the support 200 can include a first layer and a second layer, the first layer is disposed on the second layer, wherein the first layer and the second layer have different average pore sizes. In some embodiments, the MOF-GO oxide membrane 100 can be disposed on the first layer, with the first layer having a smaller average pore size than the second layer.

In some embodiments, the support 200 may include a polymeric porous support formed from materials selected from one or more of polyacrylonitrile (PAN), polyethylene terephthalate (PET), polycarbonate (PC), polyamide (PA), polysulphone (PSU), poly(ether) sulfone (PES), cellulose acetate (CA), poly(piperazine-amide), polyvinylidene fluoride (PVDF), polytetrafluoroethylene (PTFE), poly(phthalazinone ether sulfone ketone) (PPESK), polyamide-urea, poly (ether ketone), polypropylene, poly(phthalazinone ether ketone), and thin film composite porous films (TFC), suitably the TFC comprises an ultra-thin ‘barrier’ layer polymerized in situ over a porous polymeric support membrane, such as commercially available polyamide derived TFCs of an interfacially synthesized polyamide formed over a polysulphone membrane, and/or others TFCs such as poly(piperazine-amide)/poly(vinyl-alcohol) (PVA), poly(piperazine-amide)/poly(phthalazinone biphenyl ether sulfone (PPBES), hydrolyzed cellulose triacetate (CTA)/Cellulose acetate (CA) TFCs.

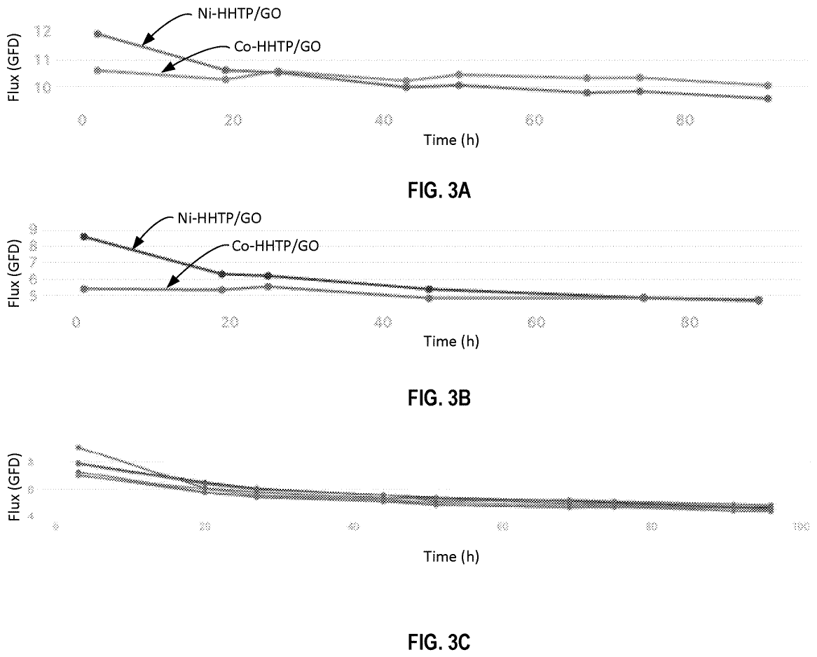

The performance of the filtration apparatus 1000 described herein can be characterized by the flux and the rejection rates for specific solute species. For example, FIGS. 3-7 show plots displaying the performance of various filtration apparatus 1000 operating in a black liquor feed. Black liquor is a byproduct of the kraft pulping process, generated during conversion of wood into cellulose fibers for pulp and paper products. The filtration apparatus 1000 can be used to process black liquor streams, as further described herein.

FIGS. 3A-3C show graphs displaying flux in gallons per square foot per day (GFD) as a function of time (in hours) for various filtration apparatus 1000 including exemplary metal organic framework modified graphene oxide (MOF-GO) membranes 100 fabricated and/or synthesized using Nickel or Cobalt metal and 2,3,6,7,10,11 Hexahydroxytriphenylene (HHTP) organic linker, as further described with reference to Example 1. FIG. 3A shows the flux of a filtration apparatus 1000 comprising a Ni-HHTP/GO membrane 100 and a Co-HHTP/GO membrane 100, in flowing a black liquor feed (a softwood Kraft black liquor) for four days in crossflow configuration at 300 psi, 70 C and a linear flow rate of 0.2 m/s. FIG. 3A shows the Ni-HHTP/GO membrane 100 and the Co-HHTP/GO membrane 100 exhibited a flux that consistently remained at or above 10 gallons per square foot per day (GFD) with the black liquor (also referred to as a weak black liquor, WBL) feed including a total concentration of solids ranging from 18.62% to 21.07%. The Ni-HHTP/GO membrane 100 exhibited a rejection rate (not shown in FIG. 1) of about 53% to 57%, with the rejection rate increasing as the total concentration of solids in the WBL feed increased. The Co-HHTP/GO membrane 100 exhibited a rejection rate (not shown in FIG. 1) that remained nearly constant at 58% for the duration of test. The rejection rate for solute species included in the WBL feed were measured by refractive index (RI) method in Degrees Brix. The rejection was calculated as calculated as

rej rate=└1−Permeate RI/Feed RI┘×100.

FIG. 3B shows the flux of a filtration apparatus 1000 comprising a Ni-HHTP/GO membrane 100 and a Co-HHTP/GO membrane 100 prepared according to Example 1, and further processed by magnetic stirring the Ni-HHTP/GO and the Co-HHTP/GO slurries described in Example 1 for 1 h with a 0.01 wt % surfynol prior to casting. Visual inspection of the casted Ni-HHTP/GO and Co-HHTP/GO membranes 100 with the added surfynol did not reveal any noticeable defects (e.g., cracks, craw feet, delamination, etc.). FIG. 3B shows the Ni-HHTP/GO and Co-HHTP/GO membranes 100 achieved a flux of 4.75 GFD after four days of operation in crossflow configuration. The performance of the Ni-HHTP/GO and Co-HHTP/GO membranes 100 shown in FIGS. 3A and 3B was found to be 2 to 3 times higher than that of a control GO membrane (not shown in FIGS. 3A-3B), which exhibited a flux in the range of 1.6 to 2.4 GFD after the same duration of time. The control GO membrane comprised graphene oxide sheets covalently coupled to a chemical spacer (e.g., a propionamide spacer). Examples of such control GO membranes and their methods of manufacture can be found in U.S. Pat. No. 11,097,227, entitled “Durable Graphene Oxide Membranes,” issued Aug. 24, 2021 (“the '227 patent”), U.S. Pat. No. 11,123,694, titled, “Filtration Apparatus Containing Graphene Oxide membrane,” issued Sep. 21, 2021 (“the '694 patent”), and International Patent Application Publication No. WO2023/064859 entitled, “Filtration Apparatus Containing Alkylated Graphene Oxide Membrane,” filed Oct. 13, 2022 (“the '859 publication”) which are incorporated herein by reference.

FIG. 3C shows the flux of a filtration apparatus 1000 including a variety of Ni-HHTP/GO membranes 100 and Co-HHTP/GO membranes 100 prepared according to Example 1. FIG. 3C shows the performance of the MOF-GO membranes was highly reproducible, with the Co-HHTP/GO membranes 100 exhibiting a flux in the range of 4.6-4.8 GFD, and the Ni-HHTP/GO membranes 100 exhibiting a flux in the range of 4.4-4.5 GFD in crossflow configuration. The permeate solids varied between 6.6-6.8% for Co-HHTP/GO membranes 100 and 7.1-7.8% for Ni-HHTP/GO membranes 100 at a feed solids concentration of 16% (the control GO membrane 100 registered 6.6% solids at the same WBL feed concentration). As disclosed above, these results indicate that the MOF-GO membranes 100 prepared as described herein are highly reproducible, and there is no noticeable difference in filtration between the Co-based and Ni-based MOF-GO membranes 100.

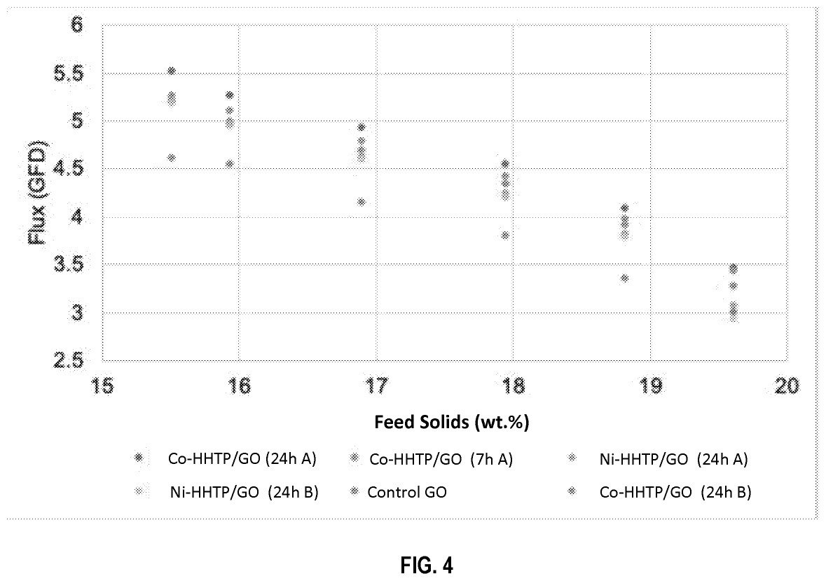

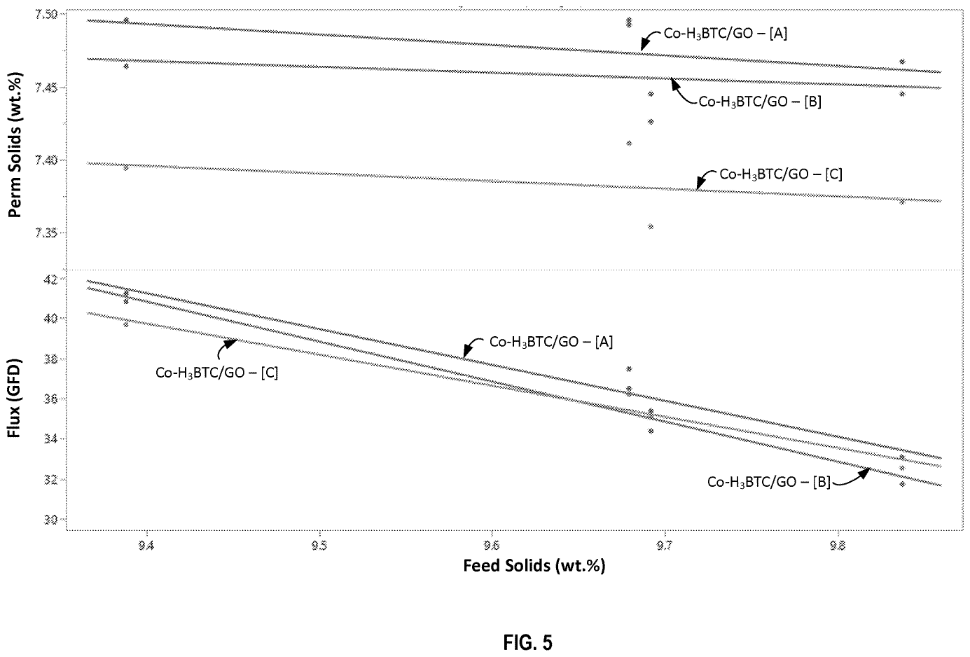

FIGS. 4 and 5 show the results of a concentration study in which exemplary MOF-GO membranes 100 were exposed to a weak black liquor feed (softwood Kraft black liquor) with varying total concentration of solids present in the feed. The performance of the MOF-GO membranes 100 shown in FIGS. 4 and 5 was recorded at a pressure of 300 psi, a temperature of 70 C, and a linear flow rate of 0.2 m/s. The MOF-GO membranes 100 shown in FIG. 4 were fabricated and/or synthesized using Nickel or Cobalt metal and 2,3,6,7,10,11 Hexahydroxytriphenylene (HHTP) organic linker, as further described with reference to Example 2. FIG. 4 shows a graph of the flux in gallons per square foot per day (GFD) as a function of the total concentration of solids (Feed solids, wt. %) included in the black liquor feed. It is worth noting that the data shown in FIG. 4 was recorded after continuous operation of the MOF-GO membranes 100 in a WBL feed having a relatively constant total concentration of solids (13.4-15.4%) at a pressure of 300 psi, a temperature of 70 C, and a linear flow rate of 0.2 m/s for consecutive 6 days in crossflow configuration, demonstrating the long term operation stability of the MOF-GO membranes. FIG. 4 shows the performance for Co-HHTP/GO membranes 100 synthesized for and 7 and 24 hours, Ni-HHTP/GO membranes 100 synthesized for 7 and 24 hours, and a control GO membrane similar to the control GO membranes described above with reference to FIG. 3B. Each one of the MOF-GO membrane 100 shown in FIG. 4 was tested in duplicate (e.g., test membrane subjects A and B). The graph reveals that the relationship between flux and concentrations of feed solids is linear for all the MOF-GO membranes 100 included in the test over a wide range of concentrations of feed solids ranging from 15.5 wt. % to 19.5 wt. %. This range of concentrations of feed solids resembles that of typical black liquor streams such as, for example a softwood Kraft black liquor. The highest fluxes obtained with the tested MOF-GO membranes 100 ranged from 4.6 GFD for the control GO membrane to 5.5 GFD for the Co-HHTP/GO membrane 100 synthesized for 24 hours (membrane A). The control GO membrane exhibited both the lowest slope and lowest absolute flux, while the MOF-GO membranes 100 showed higher slopes and higher absolute fluxes. These higher slopes suggest the MOF-GO membranes 100 have greater sensitivity to increased concentration of solids in the feed. FIG. 4 further reveals that all MOF-GO membranes 100 fabricated as described in Example 2 outperform the control GO membrane across the range of tested concentration of solids, providing experimental evidence of their superior performance.

FIG. 5 shows the performance of exemplary MOF-GO membranes 100 exposed to a WBL feed (softwood Kraft black liquor) that had been previously filtered through a 15 kDA ceramic membrane at a temperature of 90 °C and a pressure of 4 bar. The MOF-GO membranes 100 shown in FIG. 5 were fabricated and/or synthesized using Cobalt metal and 1,3,5-benzenetricarboxylic acid (H₃BTC) organic linker, as further described with reference to Examples 8 and 9. In particular, FIG. 5 shows the performance of a Co—H₃BTC/GO membrane [A] fabricated at a temperature of 80 °C using ethanol solvent and a concentrated formulation as further described in Example 8, a Co—H₃BTC/GO membrane [B] fabricated at a temperature of 60 °C using ethanol solvent and a concentrated formulation as further described in Experiment 9, and a Co—H₃BTC/GO membrane [C] fabricated at a temperature of 60 °C using isopropyl alcohol (IPA) solvent and a concentrated formulation as further described in Example 9. FIG. 5 shows the flux (GFD) and the total concentration of solids in the permeate stream (Permeate solids, wt. %) produced when operating the MOF-GO membranes 100 (e.g., membranes [A], [B], and [C]) in the WBL feed with different total concentration of solids. The MOF-GO membranes 100 in FIG. 5 exhibited a very similar performance, regardless of the specific details of their fabrication approach. The similar performance of the MOF-GO membranes 100 in FIG. 5 provides evidence that the fabrication of the MOF-GO membranes 100 via a 1-step (in-situ) procedure in which the MOF is synthesized in the presence of graphene oxide is robust process. In particular, the small variations in the performance of the MOF-GO membranes 100 suggests the 1-step fabrication approach disclosed in the present application allows replacing and/or substituting the solvent used to dissolve the organic linker to accommodate other process constrains such as, for example accommodating for a preferred MOF(s) 120 synthesis temperature and/or limited solubility of the organic linker in the reaction mixture. Said in other words, the 1-step approach disclosed herein is a robust and flexible synthesis approach that can be used to fabricate MOF-GO membranes 100 at a preferred temperature (e.g., a temperature selected to fine tune properties of the MOF(s) 120 such as size, crystallinity, shape, degree of intercalation with the graphene oxide sheets 110, etc.) by selecting the desired organic linker(s) and a solvent which can solubilize the desired organic linker (and other desired additives) without evaporating at the desired MOF(s) 120 synthesis temperature (e.g., a solvent having a boiling point compatible with the preferred temperature for the synthesis of the MOF(s) 120, and thus being less volatile).

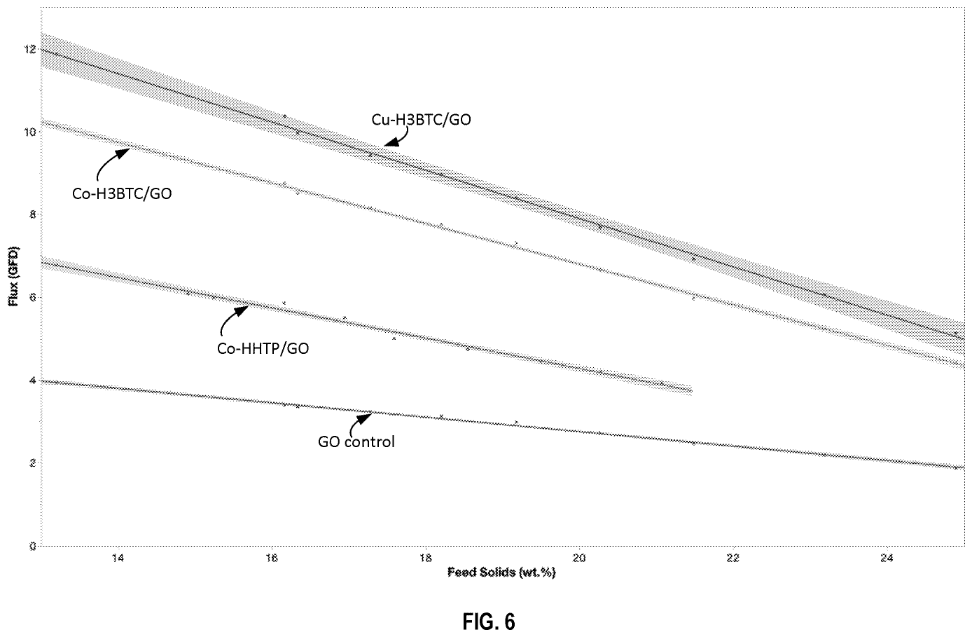

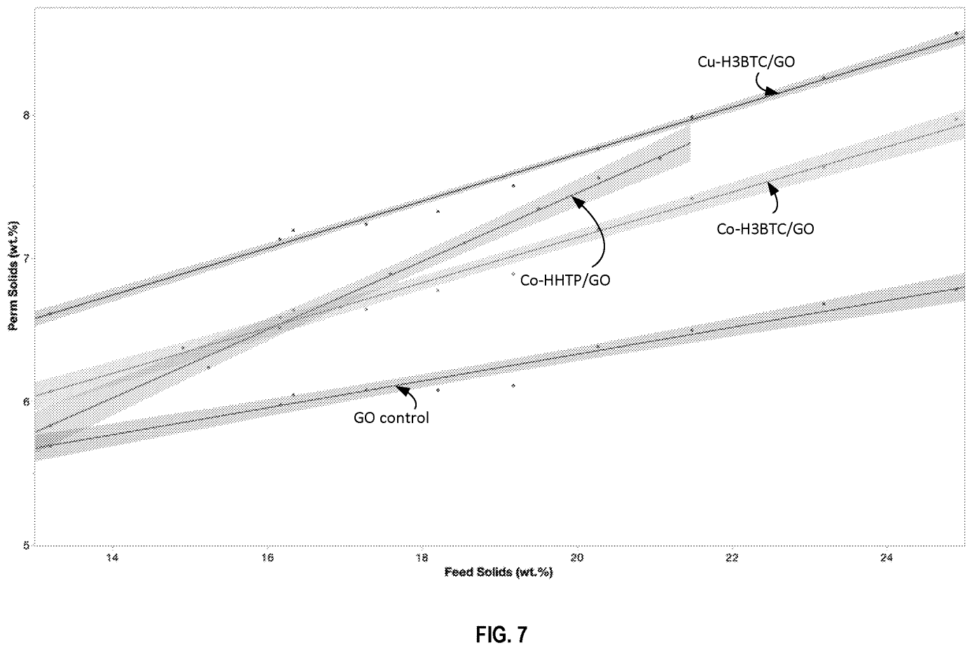

FIGS. 6 and 7 show the results of another concentration study in which exemplary MOF-GO membranes 100 were exposed to a black liquor feed varying the total concentration of solids present in the feed. The MOF-GO membranes 100 shown in FIGS. 6 and 7 include: a Cu—H₃BTC/GO membrane 100 fabricated and/or synthesized using copper nitrate and 1,3,5-tricarboxylic acid (H₃BTC) organic linker, as described with reference to Example 4, a Co—H₃BTC/GO membrane 100 fabricated and/or synthesized using cobalt acetate and (H₃BTC) organic linker, as described with reference to Example 5, a Co-HHTP/GO membrane 100 fabricated and/or synthesized as described with reference to Example 2, and a control GO membrane similar to similar to the control GO membrane described above with reference to FIGS. 3B, 4, and 5. It is worth noting that the Cu—H₃BTC/GO membrane 100 shown in FIGS. 6 and 7 incorporates a Cu—H₃BTC MOF 120 characterized by a much larger and less compressible structure that those of the Ni-HHTP or Co-HHTP MOF(s) described above with reference to FIGS. 3-5 and Examples 1-3. Without being bound by any particular theory, it is believed that a larger and less compressible structure of the Cu—H₃BTC MOF 120 may be able to adjust and/or alter the spacing of the GO sheets (e.g., tuning the d-spacing of the GO sheets) in such a way that the average tortuosity of the MOF-GO membrane 100 is decreased and thus its flux is greatly increased and/or improved with negligible impact on the rejection rate of the MOF-GO membrane.

FIG. 6 shows the flux (in GFD) of the MOF-GO membranes 100 tested in flowing a black liquor solution (Softwood Kraft black liquor) in crossflow configuration at a pressure of 300 psi, a temperature of about 60 °C, and a linear flow rate of about 0.2 m/s. Inspection of FIG. 6 reveals the Cu—H₃BTC/GO membrane 100 displayed a flux that is 2.9 times higher than the flux of the Co-HHTP/GO membrane 100 across all the range of concentration of solids tested (e.g., feed solids, wt. %). Similarly, FIG. 6 shows the Cu—H₃BTC/GO membrane 100 displayed a flux that is 2.5 times higher than the flux of the Co—H₃BTC/GO membrane 100 across all the range of feed solids tested. The improved performance shown in FIG. 6 suggests incorporation of MOFs having larger and less compressible structures may provide an approach to control the d-spacing and/or the tortuosity of the GO sheets, improving the membrane's flux characteristics. It is worth noting that the performance of the Cu—H₃BTC/GO membrane 100, the Co—H₃BTC/GO membrane 100, and the control GO membrane in FIG. 6 was measured under the same range of feed solids (between 17 and 25 wt. %), while the performance of the Co-HHTP/GO membrane 100 was measured with a different range of feed solids (between 15 and 21 wt. %). These ranges of feed solids fall partially outside of a range of operating conditions that may be desirable in certain instances (e.g., in some instances the concentration of solids in the feed is expected and/or desired to be between 10-17 wt. %). Therefore, in such instances, the performance of the MOF-GO membranes 100 shown in FIG. 6 may need to be extrapolated.

The improved flux observed for the Cu—H₃BTC/GO membrane 100 and the Co—H₃BTC/GO membrane 100 comes with a small tradeoff in permeate quality. FIG. 7 shows the total concentration of solids in the permeate stream (Permeate solids, wt. %) produced when operating the MOF-GO membranes 100 in the black liquor feed with different total concentration of solids shown in FIG. 6. FIG. 7 shows that for the range of feed solids tested in FIG. 6, the Cu—H₃BTC/GO membrane 100 exhibited between 16-18% higher permeate solids relative to the control GO membrane. That is to say, the rejection rate of the Cu—H₃BTC/GO membrane 100 was found to be lower than that of the control GO membrane. Likewise, the Co—H₃BTC/GO membrane 100 exhibited between 5-8% higher permeate solids relative to the control GO membrane. Despite this rejection rate tradeoff, the flux and the rejection rate of the Cu—H₃BTC/GO membrane 100 and the Co—H₃BTC/GO membrane 100 across the range feed solids tested are considered favorable relative to the performance of the Co-HHTP/GO membrane 100 (or an equivalent Ni-HHTP/GO membrane fabricated as described in Examples 1-3). Further inspection of FIG. 7 shows the Cu—H₃BTC/GO membrane 100 exhibited an 11% higher rejection rate compared to the Co—H₃BTC/GO membrane 100. Consequently, in some embodiments, a Cu—H₃BTC/GO membrane 100 fabricated as described with reference to Example 4 may provide an optimal combination of flux and rejection rate for the processing of black liquor.

### Manufacture of the Filtration Apparatus

In some embodiments, the fabrication of the filtration apparatus 1000 may include: (1) preparing a graphene oxide (GO) sheets 110 solution and/or dispersion, adding reagents and/or precursors for the synthesis of one or more MOF(s) 120, (2) initiating chemical reactions and/or chemical transformations at a predetermined temperature, pressure, and/or stirring conditions suitable to convert and/or transform the added reagents and/or precursors into the one or more MOF(s) 120 in the presence of the GO sheets 110, (3) optionally adding one or more chemical additives to generate a MOF-GO solution, suspension, dispersion, and/or slurry, and (4) depositing the resulting MOF-GO solution, suspension, dispersion, and/or slurry on a support 200. Alternatively, in some embodiments the fabrication of the filtration apparatus 1000 may include: (1) preparing a graphene oxide (GO) sheets 110 solution and/or dispersion, (2) preparing, separate from the GO sheets 110 solution and/or dispersion (e.g., in a separate reactor and/or vessel), one or more MOF(s) 120, (3) mixing the GO sheets 110 solution and/or dispersion and the one or more MOF(s) 120 at a predetermined temperature, pressure, and stirring conditions to produce a MOF-GO solution, suspension, dispersion, and/or slurry, and (4) depositing the resulting MOF-GO solution, suspension, dispersion, and/or slurry on a support 200.

In some embodiments, the fabrication of the MOF-GO membrane 100 includes dispersing graphene oxide (e.g., the GO sheets 110) in a solvent to produce a stable graphene oxide dispersion. In some embodiments, the solvent can be water. In some embodiments, the solvent can be ethanol. In some embodiments, the solvent can be a suitable organic solvent such as methanol, propanol, isopropanol, acetonitrile, dimethyl sulfoxide, N,N-dimethylformamide, or the like. In some embodiments, the solvent can be a mixture of water and water-miscible organic solvent. The graphene oxide dispersion may exhibit certain physical and chemical characteristics in order to produce continuous and uniform coatings substantially free of structural defects such as pinholes. For example, the hydrophilicity of the graphene oxide dispersion should be adequately matched to that of the support 200 to ensure wetting of the support 200 surface. This can be tested by contact angle measurements.

The stability of the graphene oxide dispersion can be inferred from the pH of the graphene oxide dispersion. For example, graphene oxide dispersions that exhibit acidic pH values (e.g., pH<5) can develop visible aggregates. Fabricating coatings with such graphene oxide dispersions can lead to poor coverage, coating non-uniformity, and poor membrane performance. In contrast, graphene oxide dispersions that have basic pH are stable. Moreover, addition of basic additives to the graphene oxide dispersion can increase the magnitude of the zeta potential on the graphene oxide sheets, which in turn results in greater Coulombic stabilization.

The stability of the graphene oxide dispersion can be indirectly observed through UV-Vis spectroscopy measurements, owing to the absorption band at around 300 nm, attributed to n-to-p* transitions. At longer wavelengths (>500 nm) the GO sheets 110 absorb very weakly, and consequently, any signal in this region can be attributed to scattering, rather than absorption, due to the formation of aggregates. The ratio of UV-Vis signal at 300 nm (due to absorption) and that observed at 600 nm (due to aggregate scattering) can be used to characterize the graphene oxide dispersion in the solution. Generally, the higher this ratio is, the better the GO sheets 110 are dispersed.

In some embodiments, the ratio of UV-Vis signal at 300 nm and that observed at 600 nm can be less than about 4.4, less than about 4.2, less than about 4.0, less than about 3.8, less than about 3.6, less than about 3.4, less than about 3.2, or less than about 3.0, inclusive of all values and ranges therebetween. In some embodiments, the ratio of UV-Vis signal at 300 nm and that observed at 600 nm can be at least about 3.0, at least about 3.1, at least about 3.2, at least about 3.3, or at least about 3.4, inclusive of all values and ranges therebetween.

Combinations of the above referenced ranges for the ratio of UV-Vis signal are also possible (e.g., a ratio of at least about 3.0 to less than about 4.4, at least about 3.2 to less than about 4.0).

In some embodiments, the graphene oxide dispersion can further include viscosity modifiers and/or surfactants. In some embodiments, the viscosity modifier is hydroxypropyl methyl cellulose (HPMC). For example, the graphene oxide dispersion can include 0.01 wt. % viscosity modifier. In some embodiments, the surfactant is sodium dodecyl sulfide (SDS). For example, the dispersion can include about 0.15 wt. % surfactant.

In some embodiments, the viscosity of the graphene oxide dispersion can be no more than about 20 cP at a shear rate of around 0.08 Hz, about 40 cP at a shear rate of around 0.08 Hz, about 60 cP at a shear rate of around 0.08 Hz, about 100 cP at a shear rate of around 0.08 Hz, about 200 cP at a shear rate of around 0.08 Hz, about 400 cP at a shear rate of around 0.08 Hz, about 600 cP at a shear rate of around 0.08 Hz, about 800 cP at a shear rate of around 0.08 Hz, 1000 cP at a shear rate of around 0.08 Hz, no more than about 1500 cP at a shear rate of around 0.08 Hz, no more than about 2000 cP at a shear rate of around 0.08 Hz, no more than about 2500 cP at a shear rate of around 0.08 Hz, no more than about 3000 cP at a shear rate of around 0.08 Hz, no more than about 3000 cP at a shear rate of around 0.08 Hz, no more than about 3500 cP at a shear rate of around 0.08 Hz, no more than about 4000 cP at a shear rate of around 0.08 Hz, no more than about 5000 cP at a shear rate of around 0.08 Hz, no more than about 6000 cP at a shear rate of around 0.08 Hz, or no more than about 8000 cP at a shear rate of around 0.08 Hz.

Combinations of the above referenced ranges for the viscosity of the graphene oxide dispersion are also possible (e.g., a viscosity of at least about 10 cP and to no more than about 1000 cP at a shear rate of around 0.08 Hz, at least about 200 cP to no more than about 1500 cP at a shear rate of around 0.08 Hz).

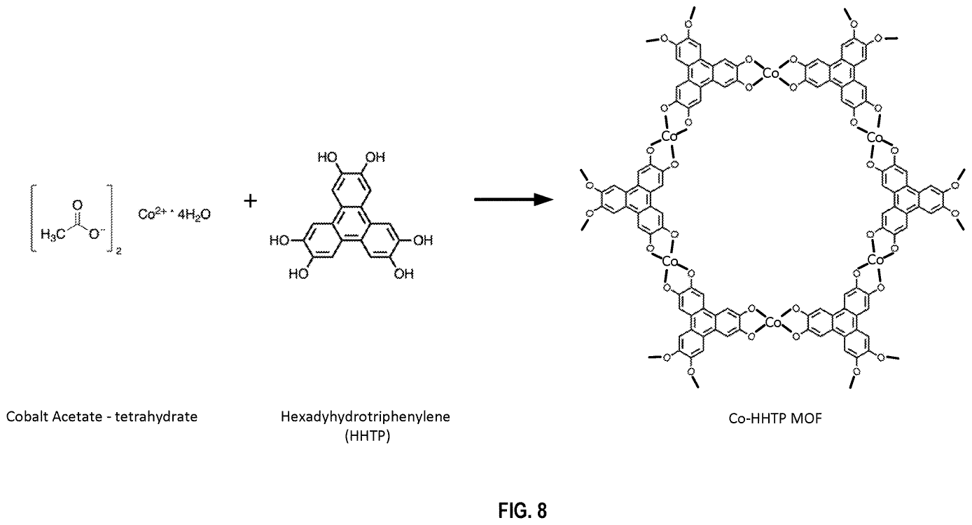

As described above, the fabrication of the filtration apparatus 1000 includes synthesizing and/or fabricating one or more MOF(s) 120. FIG. 8 shows an example chemical reaction between cobalt acetate-tetrahydrate (Co(CH₃CO₂)₂·4H₂O) and a hexahydroxytriphenylene (HHTP) organic linker to produce a MOF 120 (e.g., a Co-HHTP MOF). As shown in FIG. 8, the exemplary Co-HHTP MOF 120 includes cobalt nodes (i.e., coordinated Co metal) and organic linkers (i.e., HHTP) having functional groups capable of coordinating with Co²⁺ ions to establish a network of coordination bonds.

The preparation of organometallic frameworks as such is well known to those skilled in the art. The choice of metal and linker dictates the structure and hence properties of the produced MOF 120. As illustrated in FIG. 8, an MOF 120 can be synthesized using tetrahydrate metal salts through a process that is simple, cost-effective, and efficient. The synthesis process begins with the selection of appropriate precursors including organic linkers (e.g., HHTP) and/or metal salts (e.g., cobalt acetate tetrahydrate). In some embodiments, these materials can be dissolved in a solvent. The solvent can be any propriate solvent that can dissolve the precursors. In some embodiments, the solvent can be an organic solvent such, for example, ethanol, methanol, n-butanol, isopropyl alcohol (IPA), N,N-dimethylformamide (DMF), N,N-dimethylacetamide (DMA), or the like. In some embodiment the solvent can be water. In some embodiments, the solvent may include a mixture of water and an organic solvent. In some embodiments, the precursors (e.g., organic linkers and/or metal salts) can be mixed and stirred for a predetermined period of time. In some embodiments, the predetermined period of time may be about 60 minutes, about 120 minutes, about 3 hours, about 4 hours, about 6 hours, about 8 hours, about 12 hours, about 16 hours, about 18 hours, about 24 hours, about 48 hours, about 72 hours, or about 96 hours. In some embodiments, the precursors (e.g., organic linkers and/or metal salts) can be mixed with one or more solvent at a temperature that is dictated by properties of the one or more solvents (e.g., boiling point, solubility for the precursors, etc.). In some embodiments, the mixing temperature can be between 30 °C to 180 °C, for example in some embodiments the temperature can be about 25 °C, about 25 °C, about 30 °C, about 35 °C, about 40 °C, about 45 °C, about 50 °C, about 55 °C, about 60 °C, about 65 °C, about 70 °C, about 75 °C, about 80 °C, or about 85 °C, inclusive of all values and ranges therebetween. In some embodiments, mixing of the precursors at the mixing temperature for a predetermined period time can lead to the formation of MOF 120 crystals.

In some embodiments, the MOF 120 can then be isolated by filtration, washed with a solvent to remove any unreacted starting materials and impurities, and finally dried. The resulting MOF 120 can be further activated by removing the solvent molecules from its pores, typically by heating under vacuum.

In some embodiments, the MOF 120 can be synthesized using a hydrothermal approach and then incorporated and/or mixed with a graphene oxide dispersion.

In some embodiments, the hydrothermal approach may include synthesizing the MOF 120 at elevated temperatures (e.g., above 100 °C) under high pressure (e.g., more than 0.2 MPa). The hydrothermal approach relies on the solubility of metal salt and organic linker in hot solvent. In some embodiments, hydrothermal approach can be performed in a pressure vessel (e.g., a steel pressure vessel).

In some embodiments, the MOF 120 can be synthesized under ambient pressure.

In some embodiments, the MOF 120 can be synthesized at a temperature range between about 60 °C to about 300 °C, about 80 °C to about 300 °C, about 100 °C to 280 °C, about 120 °C to 250 °C.

In some embodiments, a method for fabricating a MOF 120 includes: (1) dispersing a metal salt and an organic linker in a solvent having a temperature greater than 60 °C; (2) stirring the metal salt and the organic linker for a predetermined period of time to produce a MOF 120, and (3) post-processing (washing with a solvent, drying under vacuum etc.) the obtained MOF 120. In some embodiments, the solvent can include water, ethanol, ethanol, methanol, n-butanol, isopropyl alcohol (IPA), N,N-dimethylformamide (DMF), N,N-dimethylacetamide (DMA), or a combination thereof. In some embodiments, the predetermined period of time may be about 60 minutes, 120 minutes, 4 hours, 6 hours, 8 hours, 12 hours, 16 hours, 18 hours, 24 hours, or 48 hours, inclusive of all values and ranges therebetween.

In some embodiments, a method for fabricating, synthesizing, and/or preparing a MOF-GO membrane 100 can be a 2-step method and/or procedure including a first step in which a graphene oxide dispersion containing GO sheets 110 and one or more MOF(s) 120 and are separately fabricated and/or prepared, and a second step in which the graphene oxide dispersion and the MOF(s) 120 are mixed at a predetermined and/or preferred temperature, pressure, and under agitation and/or stirring to produce a MOF-GO solution, dispersion and/or slurry which can be coated and/or casted to yield a MOF-GO membrane 100. For example, in some embodiments a method for fabricating, synthesizing, and/or preparing a MOF-GO membrane 100 can include: (1) preparing a graphene oxide dispersion containing the GO sheets 110 according to procedures and/or methods similar to and/or the same as those described above, (2) separately from the graphene oxide dispersion (e.g., in a separate reactor and/or vessel), preparing one or more MOF(s) 120 by mixing and reacting precursors and/or reagents such as a metal reagent and an organic linker according to procedures and/or methods similar to and/or the same as those described above, (3) mixing the graphene oxide dispersion comprising the GO sheets 110 with the one or more MOF(s) 120 at a pre-determined temperature, under agitation and/or stirring, and for a certain period of time to produce a MOF-GO solution, dispersion and/or slurry, and (4) coating and/or casting the resulting solution, dispersion and/or slurry on a support 200 to yield an MOF-GO membrane 100. In some embodiments, the stirring includes using a high shear mixing. In some embodiments, the method may optionally include filtrating the resulting MOF-GO solution, dispersion and/or slurry and washing the filtrate with an appropriate solvent.

In some embodiments a method for fabricating, synthesizing, and/or preparing a MOF-GO membrane 100 can be a 1-step method and/or procedure in which a graphene oxide dispersion containing GO sheets 110 and precursors and/or reagents such as a metal reagent and an organic linker are mixed at a predetermined and/or preferred temperature, pressure, and under agitation and/or stirring conditions selected to facilitate the in-situ formation of one or more MOF(s) 120 in the presence of the GO sheets 110, and the subsequent formation of a MOF-GO solution, dispersion and/or slurry that can be coated and/or casted to yield a MOF-GO membrane 100. For example, in some embodiments a method for fabricating, synthesizing, and/or preparing a MOF-GO membrane 100 can include: (1) preparing a dispersion of graphene oxide (e.g., a graphene oxide dispersion comprising a GO sheets 110 at a predetermined concentration), (2) mixing the graphene oxide dispersion with one or more precursors and/or reagents such as metal-containing reagents (e.g., metal nodes as those described above) and organic linkers (e.g., organic molecules such as those described above), (3) stirring the resulting mixture of graphene oxide and the precursors and/or reagents at a predetermined temperature, pressure under agitation and/or stirring for a period of time to facilitate the formation of one or more MOF(s) 120 in the presence of the GO sheets 110, (4) forming a MOF-GO solution, dispersion and/or slurry, and (5) coating and/or casting the resulting MOF-GO solution, dispersion and/or slurry on a support 200 to yield an MOF-GO membrane 100. In some embodiments, in-situ synthesis of the MOF(s) 120 in presence of GO sheets 110 may lead to formation of MOF(s) 120 nanoparticles and/or crystals. In some embodiments, the method may optionally include filtrating the resulting MOF-GO solution, dispersion and/or slurry and washing the filtrate with an appropriate solvent. In some embodiments, a method for fabricating, synthesizing, and/or preparing a MOF-GO membrane 100 can include: (1) dissolving an organic linker (e.g., HHTP, H₃BTC, or the like) in a solvent at a preferred temperature in a suitable vessel and/or reactor, (2) adding to the vessel and/or reactor a dispersion of graphene oxide (e.g., a graphene oxide dispersion comprising a GO sheets 110 at a predetermined concentration), and (3) adding to the vessel and/or reactor one or more metal salts, and (4) adjusting the temperature, providing suitable agitation conditions (e.g., agitating with a stirrer, high shear mixer, or the like) for a predetermined period of time (e.g., 0.5 hours to 48 hours). In some implementations, dissolving the organic linker (step 1 above) can include dissolving the organic linker in a solvent such as ethanol, propanol, isopropanol, isopropyl alcohol (IPA), N,N-dimethylformamide (DMF), N,N-dimethylacetamide (DMA), or a combination thereof in a reactor and/or vessel. The organic linker can be dissolved in the solvent at a preferred temperature such as for example, about 25 °C, about 25 °C, about 30 °C, about 35 °C, about 40 °C, about 45 °C, about 50 °C, about 55 °C, about 60 °C, about 65 °C, about 70 °C, about 75 °C, about 80 °C, or about 85 °C, inclusive of all values and ranges therebetween. The organic linker can be dissolved in the solvent while heating (to keep the reactor at the preferred temperature) and providing agitation to facilitate adequate mixing. For example, in some implementations the organic linker can be dissolved in the solvent while agitating the vessel and/or reactor with a stirrer operating at a suitable rotational speed such as for example, 50 rpm, 75 rpm, 100 rpm, 125 rpm, 150 rpm, 175 rpm, 200 rpm, 250 rpm, 300 rpm, or 500 rpm, inclusive of all values and ranges therebetween. In some implementations, adding to the vessel and/or reactor a dispersion of graphene oxide (step 2 above) can include adding the graphene oxide dispersion to the dissolved organic linker while providing agitation and/or heat, as described above. In some implementations, adding to the vessel and/or reactor one or more metal salts (step 3 above) can include adding the metal salts to the vessel and/or reactor while providing agitation and/or heat, as described above. Further details on the fabrication of the MOF-GO membranes can be found in the Examples below.

In some embodiments, a method for fabricating, synthesizing, and/or preparing a MOF-GO membrane 100 can include preparing a dispersion of graphene oxide containing GO sheets 110. In some embodiments, the dispersion of graphene oxide can include a preferred and/or predetermined concentration of GO sheets 100. For example, in some embodiments the concentration of GO sheets 110 in the graphene oxide dispersion can be at least about 0.1 mg/mL, at least about 0.01 mg/mL, at least about 0.04 mg/mL, at least about 0.08 mg/mL, 0.1 mg/mL, at least about 0.1 mg/mL, at least about 0.2 mg/mL, at least about 0.4 mg/mL, at least about 0.6 mg/mL, at least about 0.8 mg/mL, at least about 1 mg/mL, at least about 1.5 mg/mL, at least about 2 mg/mL, at least about 2.5 mg/mL, at least about 3 mg/mL, at least about 3.5 mg/mL, at least about 4 mg/mL, at least about 4.5 mg/mL, or at least about 5 mg/mL, inclusive of all values and ranges therebetween.

In some embodiments, a method for fabricating, synthesizing, and/or preparing a MOF-GO membrane 100 can include preparing a dispersion of graphene oxide containing GO sheets 110. In some embodiments, one or more chemical reagents and/or additives can be added to the graphene oxide dispersion. For example, in some embodiments a predetermined amount of a solvent can be added to the graphene oxide dispersion to adjust the concentration of GO sheets 110 in the solution/dispersion. Optionally, in some embodiments, a predetermined amount of a pH adjusting reagent can be added to the graphene oxide dispersion. For example, in some embodiments a predetermined amount of a base, a salt, a buffer and/or the like can be added to the graphene oxide dispersion to adjust the pH. In some embodiments, the graphene oxide dispersion can be agitated, stirred, sonicated, mixed, and/or the like to mix and/or disperse the GO sheets 110 and the added reagents. In some embodiments the graphene oxide dispersion with the added reagents can be agitated, stirred, sonicated, mixed for a predetermined period of time. In some embodiments, the predetermined period of time can be at least about 5 min, at least about 10 min, at least about 15 min, at least about 20 min, at least about 25 min, at least about 30 min, at least about 35 min, at least about 40 min, at least about 45 min, at least about 50 min, at least about 60 min, at least about 70 min, at least about 80 min, at least about 90 min, at least about 100 min, at least about 110 min, or at least about 120 min, inclusive of all values and ranges therebetween.

In some embodiments, a method for fabricating, synthesizing, and/or preparing a MOF-GO membrane 100 can include adding at least one of an organic linker or a metal-containing species in solid form to a graphene oxide dispersion (e.g., a dispersion containing GO sheets 110). In some embodiments, a metal-containing species can be added into the graphene oxide dispersion in a solid form. In some embodiments, an organic linker can be added into the graphene oxide dispersion in a solid form. In some embodiments, at least one of an organic linker or a metal-containing species can be added to the graphene oxide dispersion in a diluted form in a solvent. In some embodiments, a temperature of the graphene oxide dispersion can be increased above 50 °C after addition of MOF(s) 120 precursors such as an organic linker and/or a metal-containing species.

In some embodiments, a method for fabricating, synthesizing, and/or preparing a MOF-GO membrane 100 can include incorporating one or more MOF(s) 120 to a graphene oxide dispersion (e.g., a dispersion comprising GO sheets 110). In some embodiments, the MOF(s) 120 can be mixed with the graphene oxide dispersion using any suitable means. For example, in some embodiments the MOF(s) 120 can be mixed with the graphene oxide dispersion and the resulting mixture can be stirred using a high shear mixer to produce a MOF-GO solution, dispersion, and/or slurry. The resulting MOF-GO solution, dispersion, and/or slurry can then be casted and/or coated on a support 200.

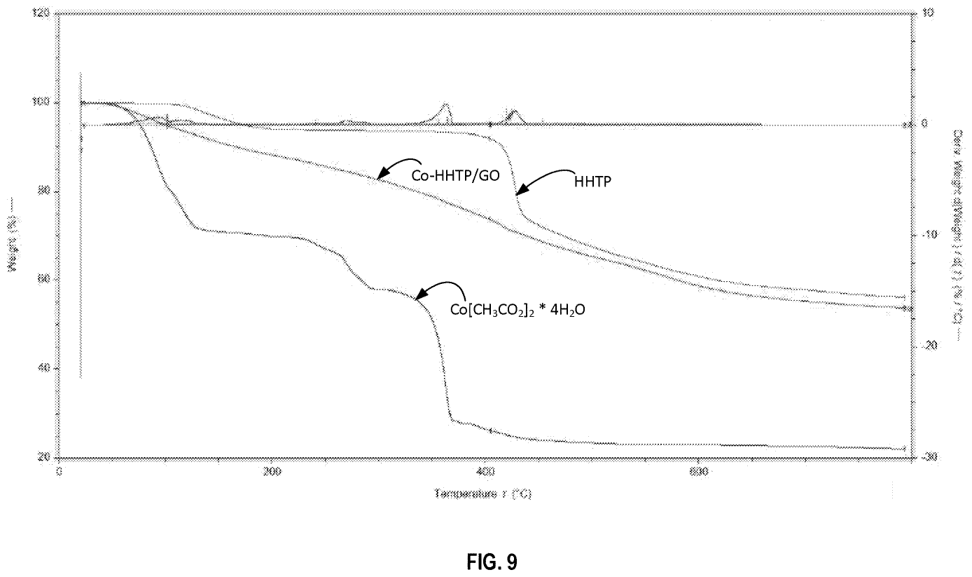

FIG. 9 shows thermogravimetric analysis (TGA) curves of an organic linker (HHTP), a metal-containing species (cobalt acetate tetrahydrate, Co[CH₃CO₂]₂) and Co-HHTP/GO membrane 100 prepared and/or produced as described with respect to Example 1. TGA was used to confirm the formation of the Co-HHTP/GO membrane 100. Comparison of the TGA curves (mass as a function of temperature) of HHTP, cobalt acetate tetrahydrate, and the Co-HHTP/GO membrane 100 shows that the Co-HHTP/GO membrane 100 exhibits decomposition peaks at temperatures similar to those of HHTP and cobalt acetate tetrahydrate. In other words, the TGA curve of the Co-HHTP/GO membrane 100 embodies characteristics from the TGA curves of both HHTP and cobalt acetate tetrahydrate. Thus, the TGA curves presented in FIG. 9 provides evidence of the successful preparation of a MOF-GO membrane 100 from its precursors.

In some embodiments, a method for fabricating, synthesizing, and/or preparing a MOF-GO membrane 100 can include allowing a graphene oxide dispersion (e.g., a dispersion containing GO sheets 110), one or more MOF(s) 120, and/or any additive, to mix at a predetermined temperature and/or pressure. In some embodiments, the predetermined temperature can be room temperature. In some embodiments, the predetermined temperature can be at least about 28 °C, at least about 30 °C, at least about 35 °C, at least about 40 °C, at least about 50 °C, at least about 60 °C, at least about 70 °C, at least about 80 °C, at least about 90 °C, at least about 100 °C, at least about 110 °C, at least about 120 °C, at least about 130 °C, at least about 140 °C, at least about 150 °C, at least about 160 °C, or at least about 180 °C, inclusive of all values and ranges therebetween. In some embodiments, the predetermined temperature can be no more than about 175 °C, no more than about 160 °C, no more than about 145 °C, no more than about 130 °C, no more than about 115 °C, no more than about 100 °C, no more than about 75 °C, no more than about 60 °C, no more than about 45 °C, or no more than 30 °C, inclusive of all values and ranges therebetween

In some embodiments, a method for fabricating, synthesizing, and/or preparing a MOF-GO membrane 100 may include stirring a MOF-GO solution, dispersion and/or slurry for a predetermined period of time at a stirring rate of least about 250 rpm, at least about 300 rpm, at least about rpm, at least about 800 rpm, at least about 1000 rpm, at least about 3000 rpm, at least about 5000 rpm, or at least about 10000 rpm, inclusive of all values and ranges therebetween.

In some embodiments, a method for fabricating, synthesizing, and/or preparing a MOF-GO membrane 100 can include adjusting the viscosity of a MOF-GO solution, dispersion and/or slurry to facilitate coating and/or casting the MOF-GO solution, dispersion and/or slurry on a support 200.

In some embodiments, a MOF-GO solution, dispersion and/or slurry fabricated according to any of the embodiments of the present disclosure can be treated by addition of selected additive(s) and/or high shear mixing such that the viscosity of the MOF-GO solution, dispersion and/or slurry measured at room temperature (or a temperature between 20 and 25 °C) is at least about 500 cP, at least about 600 cP, at least about 800 cP, at least about 1000 cP, at least about 1200 cP, at least about 1200 cP, at least about 1400 cP, at least about 1600 cP, at least about 2000 cP, at least about 3500 cP, or at least about 4000 cP, inclusive of all values and ranges therebetween.

A described above, the fabrication of the filtration apparatus 1000 requires depositing a MOF-GO solution, dispersion and/or slurry on a support 200. In some embodiments, the MOF-GO solution, dispersion and/or slurry can be deposited on the support 200 using one or more coating techniques. For example, in some embodiments the MOF-GO solution, dispersion and/or slurry can be deposited using coating techniques such as solvent casting, spin coating, cold spray coating, dip casting, drop casting, and/or tape casting. In some embodiments, the MOF-GO solution, dispersion and/or slurry can be coated onto one side of a support 200 using a casting rod. The casted MOF-GO solution, dispersion and/or slurry can then be allowed to dry at room temperature and/or at any suitable temperature (e.g., in an oven) to produce the MOF-GO membrane 100. Additionally, and/or optionally, in some embodiments, the MOF-GO membrane 100 can be further washed with a suitable solvent. For example, in some embodiments, the MOF-GO membrane 100 can be washed with one or more solvents including, but not limited to ethanol, propanol, and/or any suitable aliphatic alcohol (e.g., R—OH), dichloromethane, acetonitrile, dimethyl sulfoxide, acetone, dimethylformamide (DMF), dioxane, butanone, carbon tetrachloride.

In some embodiments, mixing can be followed by any one of the optional processing steps stirring, ultrasonication, hydrothermal reduction, spray hydrolysis, freeze-drying, vacuum filtration, high-temperature reduction and/or grinding the MOF-GO solution, dispersion and/or slurry.

In some embodiments, an MOF-GO solution, dispersion and/or slurry prepared as described above can be formed into a membrane by using any known suitable technique in the art. For example, casting can be performed by using any known casting technique in the art. In some embodiments, the MOF-GO solution, dispersion and/or slurry can be vacuum casted. That is, the MOF-GO slurries can be drawn into a mold using a vacuum.

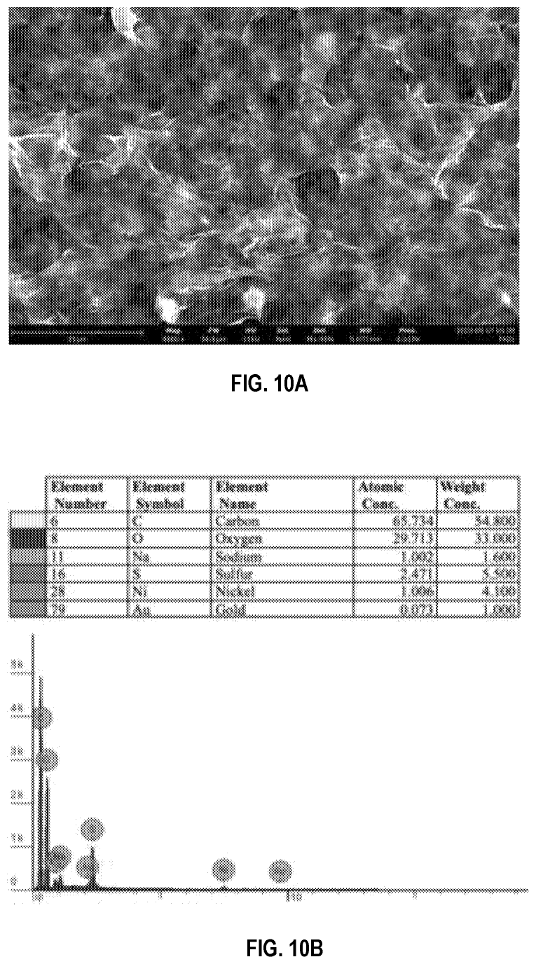

FIGS. 10A and 10B show a Scanning Electron Microscopy (SEM) image and corresponding Energy Dispersive Spectroscopy (EDS) graph recorded from the surface of a filtration apparatus 1000 including a Ni-HHTP/GO membrane 100 prepared and/or produced as described with reference to Example 1. SEM was used to visualize the morphology of the Ni-HHTP/GO membrane 100 and confirm the absence of any microscopic defects. The SEM image of FIG. 10A shows the synthesized HHTP/GO membrane 100 exhibited uniform microstructure. EDS was used to detect the presence of Ni metal in the Ni-HHTP/GO membrane 100, confirming the successful formation of a MOF-GO membrane 100.

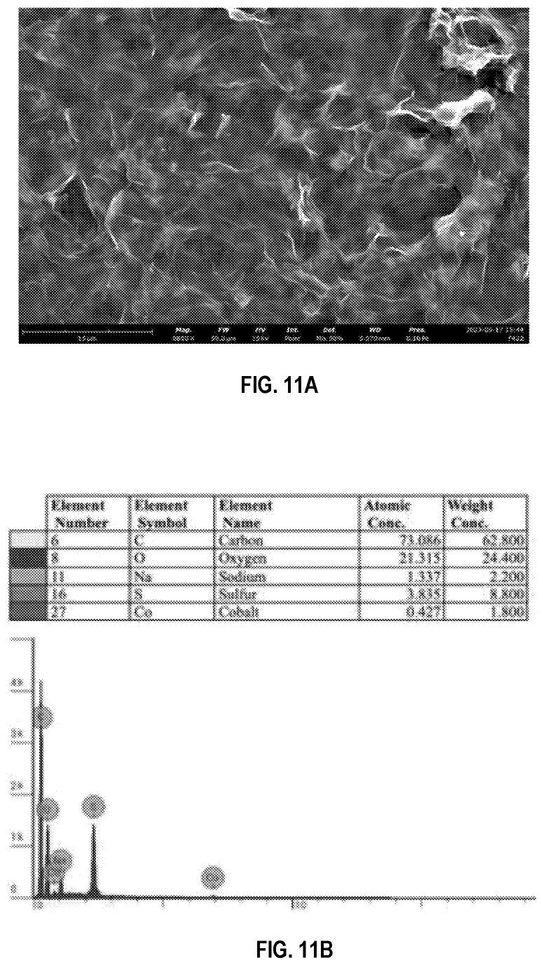

FIGS. 11A and 11B display a Scanning Electron Microscopy (SEM) image and corresponding Energy Dispersive Spectroscopy (EDS) graph, recorded from the surface of a filtration apparatus 1000 including a Co-HHTP/GO membrane 100 prepared and/or produced as described with reference to Example 1. SEM was utilized to examine the morphology of the Co-HHTP/GO membrane 100 and to confirm the absence of any microscopic defects. The SEM image of FIG. 11A shows the synthesized HHTP/GO membrane 100 has a wrinkled and rough microstructure. EDS was used to detect the presence of Co metal in the Co-HHTP/GO membrane 100, thereby confirming the presence of the MOF 120 in the Co-HHTP/GO membrane 100. The detection of Co metal on the Co-HHTP/GO membrane 100 surface further substantiates the presence of MOF 120 in the final MOF-GO membrane 100.

### Applications of the Filtration Apparatus

The filtration apparatus 1000 disclosed herein can be used for a wide range of nanofiltration or microfiltration applications, including but not limited to, concentration of molecules (e.g., whey, lactose), kraft pulping (e.g., wood pulp), sulfite pulping, demineralization or desalting (e.g., lactose, dye, chemicals, pharmaceuticals), fractionation (e.g., sugars), extraction (e.g., nutraceuticals, plant oils), recovery (e.g., catalyst, solvent), and purification (e.g., pharmaceutical, chemical, fuel), as well as applications in which high chemical stability and high monovalent and divalent ion rejection are required, such as acid concentration, sucrose concentration, and/or homogeneous catalyst concentration and/or purification. For example, a fluid comprising a plurality of species (e.g., plurality of retentate species) may be placed in contact with a first side of the MOF-GO membrane 100. The MOF-GO membrane 100 may have interlayer spacing and/or intralayer spacing that are sized to prevent at least a portion of the species from traversing the membrane through the interlayer spacing and/or intralayer spacing, i.e., flowing from the first side of the MOF-GO membrane 100 and to a second, opposing side of the MOF-GO membrane 100. In some embodiments, the fluid may include one or more types of species (e.g., a retentate species or a permeate species). In some embodiments, the MOF-GO membrane 100 may have an average interlayer spacing and/or intralayer spacing that is sized to prevent at least a portion of the retentate species from traversing the MOF-GO membrane 100, while allowing at least a portion (e.g., substantially all) of the permeate species to traverse the MOF-GO membrane 100.

The filtration apparatus 1000 disclosed herein can also be used for the concentration of black liquor. As described above, black liquor is a byproduct of the kraft pulping process generated during conversion of wood into cellulose fibers for pulp and paper products. Black liquor produced in pulp mills, (also referred to as Weak Black Liquor, WBL) is a dilute solution that can contain sodium sulfate, sodium carbonate, sodium hydrosulfide, sodium thiosulfate, and/or sodium hydroxide, residual fibers from the pulping process, as well as larger size (e.g., high molecular weight) organic species including hemicellulose, cellulose, and lignin, among others. In some instances, WBL streams can have a total concentration of solids in the range of approximately 10 to 20 wt. %. WBL solutions from pulp digestion is generally produced at 60 °C to 90 °C. Cooling the WBL prior to filtration would be very expensive and energy intensive. Without the need for cooling, the WBL can pass through the MOF-GO membrane 100 described herein at a high temperature, e.g., 60 °C to 75 °C, 75 °C to 85 °C, or 80 °C to 90 °C, inclusive of all values and ranges therebetween. In some embodiments, WBL solutions can be flowed through the filtration apparatus 1000 described herein, wherein the WBL solution comprises lignin, sodium sulfate, sodium carbonate, sodium hydrosulfide, sodium thiosulfate, sodium hydroxide, as well as larger size organic species including hemicellulose, and cellulose.

In some embodiments, the WBL solutions can include a content of total dissolved solids prior to filtration of at least about 2 wt. %, at least about 3 wt. %, at least about 5 wt. %, at least about 7 wt. %, at least about 9 wt. %, at least about 11 wt. %, at least about 13 wt. %, at least about 15 wt. %, at least about 17 wt. % at least about 19 wt. %, at least about 21 wt. %, at least about 23 wt. %, or at least about 25 wt. %, inclusive of all values and ranges therebetween. In some embodiments, the WBL solutions can include a content of total dissolved solids of no more than about 25 wt. %, no more than about 22 wt. %, no more than about 20 wt. %, no more than about 18 wt. %, no more than about 16 wt. %, no more than about 14 wt. %, no more than about 12 wt. %, no more than about 10 wt. %, no more than about 8 wt. %, no more than about 6 wt. %, no more than about 4 wt. %, or no more than about 2 wt. %, inclusive of all values and ranges therebetween.

In some embodiments, the WBL solutions can have a pH prior to filtration of about 10, of about 10.5, of about 11, of about 11.5, of about 12, of about 12.5, or of about 13.

The performance of the filtration apparatus 1000 for WBL filtration can be assessed by the rejection rate on a total solids basis. In some embodiments, the rejection rate is between about 55% and about 85% on a total solids basis, e.g., between about 60% and about 70%, between about 65% and about 75%, or between 70% and about 85% on a total solids basis.

In some embodiments, the filtration apparatus 1000 can reject at least a portion of the lignin. In some embodiments, the filtration apparatus 1000 can reject at least about 50%, at least about 55%, at least about 60%, at least about 65%, at least about 70%, at least about 75%, at least about 80%, at least about 85%, at least about 90%, at least about 95%, at least about 98%, or at least about 99% of the lignin.

In some embodiments, the filtration apparatus 1000 can reject at least a portion of the sodium sulfate. In some embodiments, the filtration apparatus 1000 can reject at least about 50%, at least about 55%, at least about 60%, at least about 65%, at least about 70%, at least about 75%, or at least about 85% of the sodium sulfate.

In some embodiments, the filtration apparatus 1000 can reject at least a portion of the sodium carbonate. In some embodiments, the filtration apparatus 1000 can reject at least about 50%, at least about 55%, at least about 60%, at least about 65%, at least about 70%, at least about 75%, or at least about 85% of the sodium carbonate.

In some embodiments, the filtration apparatus 1000 can reject at least a portion of the sodium hydrosulfide. In some embodiments, the filtration apparatus 1000 can reject at least about 50%, at least about 55%, at least about 60%, at least about 65%, at least about 70%, at least about 75%, or at least about 85% of the sodium hydrosulfide.

In some embodiments, the filtration apparatus 1000 can reject at least a portion of the sodium thiosulfate. In some embodiments, the filtration apparatus 1000 can reject at least about 50%, at least about 55%, at least about 60%, at least about 65%, at least about 70%, at least about 70%, or at least about 85% of the sodium thiosulfate.

In some embodiments, the filtration apparatus 1000 can reject at least a portion of the sodium species included in the WBL solution. In some embodiments, the filtration apparatus 1000 can reject at least about 50%, at least about 55%, at least about 60%, at least about 65%, at least about 70%, at least about 75%, or at least about 85% of the sodium species included in the WBL solution.

The filtration apparatus 1000 disclosed herein can be used in reverse osmosis to remove ions, molecules, and larger particles from a fluid, e.g., drinking water.

In some embodiments, the filtration apparatus 1000 disclosed herein can be used in methods for filtering raw milk, cheese whey, whey protein concentrate, mixtures comprising lactose, and whey protein isolate. The methods can include flowing the raw milk through the graphene oxide membrane.

In some embodiments, the filtration apparatus 1000 can have a flux greater than about 4.0 GFD, greater than about 4.5 GFD, greater than about 5.0 GFD, greater than about 5.5 GFD, greater than about 6.0 GFD, greater than about 6.5 GFD, greater than about 7.0 GFD, greater than about 7.5 GFD, greater than about 8.0 GFD, greater than about 8.5 GFD, greater than about 9.0 GFD, greater than about 9.5 GFD, greater than about 10 GFD, greater than about 12 GFD, greater than about 14 GFD, greater than about 16 GFD, greater than about 18 GFD, greater than about 20 GFD, greater than about 25 GFD, greater than about 30 GFD, greater than about 40 GFD, or greater than about 50 GFD, measured with a weak black liquor solution containing between about 2 and 20 wt. % total dissolved solids including, for example, sodium sulfate, sodium carbonate, sodium hydrosulfide, sodium thiosulfate, sodium hydroxide, tall oils, carbohydrates, lignin, cellulose, hemicellulose, or a combination thereof, at a cross flow velocity of at least 0.1 m/sec, a predetermined pressured, and a temperature of at least 50 °C.

In some embodiments, the filtration apparatus 1000 can have a flux of less than about 50 GFD, less than about 40 GFD, less than about 30 GFD, less than about 20 GFD, less than about 15 GFD, less than about 10 GFD, measured with weak black liquor at a linear flow rate of at least 0.2 m/s, a predetermined pressure, and a temperature of at least 50 °C.

Combinations of the above-referenced ranges for the flux are also contemplated (e.g., greater than about 8.0 GFD and less than about 12 GFD, or greater than about 5 GFD and less than about 30 GFD).

In some embodiments, the flux is measured at a predetermined pressure of 50 psi to 1000 psi, such as about 50 psi, about 75 psi, about 100 psi, about 125 psi, about 150 psi, about 175 psi, about 200 psi, about 225 psi, about 250 psi, about 275 psi, about 300 psi, about 325 psi, about 350 psi, about 375 psi, about 400 psi, about 425 psi, about 450 psi, about 475 psi, about 500 psi, about 525 psi, about 550 psi, about 575 psi, about 600 psi, about 625 psi, about 650 psi, about 675 psi, about 700 psi, about 725 psi, about 750 psi, about 775 psi, about 800 psi, about 825 psi, about 850 psi, about 875 psi, about 900 psi, about 925 psi, about 950 psi, about 975 psi, or about 1000 psi.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

### DEFINITIONS

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” Any ranges cited herein are inclusive.

The terms “substantially”, “approximately,” and “about” used throughout this Specification and the claims generally mean plus or minus 10% of the value stated, e.g., about 100 would include 90 to 110.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, “wt. %” refers to weight percent.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “chemical linker” refers to a molecule that can couple two adjacent graphene oxide sheets through a covalent bond, a noncovalent interaction, or a combination thereof. Non-limiting examples of noncovalent interactions include ionic interactions, hydrogen bonding, halogen bonding, Van der Waals forces (e.g., dipole-dipole interactions, dipole-induced dipole interactions, or London dispersion forces), π-effects (e.g., π-π interactions, cation-π interactions, anion-π interactions, or polar-π interactions), and the hydrophobic effect.

As used herein, the term “flux” describes the permeability of a membrane. The term “flux” means flow rate.

As used herein, the term “molecular weight cutoff” refers to at least 90% (e.g., at least 92%, at least 95%, or at least 98%) rejection rate for molecules with molecular weights greater than the cutoff value.

As used herein in the specification and in the claims, the term “room temperature” can refer to a temperature of about 15 °C, about 16 °C, about 17 °C, about 18 °C, about 19 °C, about 20 °C, about 21 °C, about 22 °C, about 23 °C, about 24 °C, or about 25 °C. In some embodiments, the room temperature is about 20 °C.

As used herein in the specification and in the claims, the term “substantially the same” refers to a first value that is within 10% of a second value. For example, if A is substantially the same as B, and B is 100, A can have a value ranging from 90 to 110. If A is substantially the same as B, and B is 200, A can have a value ranging from 180 to 220.

As used herein, the term “about” and “approximately” generally mean plus or minus 10% of the value slated, e.g., about 250 μm would include 225 μm to 275 μm, about 1,000 μm would include 900 μm to 1,100 μm. As used herein in the specification and in the claims, the term “aspect ratio” can be defined as a ratio of an in-plane lateral dimension to the thickness of the final product. For example, if a graphene oxide sheet has an average lateral dimension of 300 μm and a thickness of 200 nm, the sheet size to thickness ratio, or “aspect ratio” can be defined as 300,000/200, or 1,500.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

### EXAMPLES

### Examples 1-3

### Fabrication of MOF-GO Membranes 100 by a 1-Step (In-Situ) Procedure Including Synthesis of Ni-HHTP or Co-HHTP MOFs in the Presence of GO Sheets 110.

### Example 1

MOF-GO membranes 100 were prepared according to the following procedure: (1) 250 mL of an aqueous graphene oxide dispersion were added to a 1 L reactor. (2) 250 mL of water were added to the 1 L reactor to produce a diluted graphene oxide dispersion. (3) 1.56 g (6.26 mmol) of Cobalt acetate or Nickel acetate were added to the diluted graphene oxide dispersion contained in the 1 L reactor. (4) 1.01 g (3.11 mmol) of hexahydroxytriphenylene (HHTP) were subsequently added to the diluted graphene oxide dispersion contained in the 1 L reactor. The amounts of nickel/cobalt acetate and HHTP were set to achieve a MOF:GO ratio of 1:2. (5) The resulting graphene oxide dispersion was stirred at 80 °C for a duration of 24 hours to produce a Co-HHTP/MOF-GO slurry or a Ni-HHTP/MOF-GO slurry with a concentration of graphene oxide of about 0.2 mg/mL. (6) The Co-HHTP/MOF-GO and the Ni-HHTP/MOF-GO slurries were coated and/or casted on a support 200.

### Example 2

MOF-GO membranes 100 were prepared according to the following procedure: (1) 500 mL of graphene oxide dispersion were added to a 1 L reactor. (2) 1.56 g (6.26 mmol) of Cobalt acetate or Nickel acetate were added to the graphene oxide dispersion contained in the 1 L reactor. (3) 1.01 g (3.11 mmol) of hexahydroxytriphenylene (HHTP) were subsequently added to the graphene oxide dispersion contained in the 1 L reactor. The amounts of nickel/cobalt acetate and HHTP were set to achieve a MOF:GO ratio of 1:2. (4) The resulting graphene oxide dispersion (~0.2 mg/mL GO) was stirred at 60 °C for a duration of 24 hours to produce a Co-HHTP/GO slurry or a Ni-HHTP/GO slurry. (5) After 7 hours into the stirring process, 250 mL aliquots of the graphene oxide dispersion were taken and diluted with 250 mL of water to produce additional Co-HHTP/GO and Ni-HHTP/GO slurries with a concentration of graphene oxide of about 2.67 mg/mL. (6) The resulting Co-HHTP/GO or Ni-HHTP/GO slurries were coated and/or casted on a support 200.

### Example 3

MOF-GO membranes 100 were prepared according to the following procedure: (1) 500 mL of an aqueous graphene oxide dispersion were added to a 1 L reactor. (2) 0.78 g (3.13 mmol) of Cobalt acetate or Nickel acetate were added to the graphene oxide dispersion contained in the 1 L reactor. (3) 0.50 g (1.57 mmol) of hexahydroxytriphenylene (HHTP) were subsequently added to the graphene oxide dispersion contained in the 1 L reactor. The amounts of nickel/cobalt acetate and HHTP were set to achieve a MOF:GO ratio of 1:4. (4) The resulting graphene oxide dispersion was stirred at 70 °C for a duration of 24 hours to produce a Co-HHTP/GO slurry or a Ni-HHTP/GO slurry with a concentration of graphene oxide of about 4.0 mg/mL. The stirring speed was set to 300 rpm to prevent agglomeration of graphene oxide. (5) The Co-HHTP/GO slurry and the Ni-HHTP/GO slurry underwent high shear mixing at 3000 rpm using an emulsion head for a duration of 20-60 minutes. (6) The resulting Co-HHTP/GO or Ni-HHTOP/GO slurries were subsequently coated and/or casted on a support 200.

All MOF-GO membranes 100 fabricated as described by Examples 1-3 yielded successful results, producing membranes 100 which exhibited consistent and reproducible filtration performance. Despite variations in temperature, reaction time, and graphene oxide concentration across the batches, the MOF-GO membranes did not exhibit any noticeable difference in filtration performance. This suggests that the formulation described in Examples 1-3 are robust under a wide range of process conditions, including temperatures of 60-80 °C, durations of 7-24 hours, graphene oxide concentrations between 0.2 to 4 mg/mL, and different mass ratios of MOF:GO (i.e., mass loadings 1:2 to 1:4).

### Example 4

### Fabrication of MOF-GO Membranes 100 by a 1-Step (In-Situ) Procedure Including Synthesis of Cu—H₃BTC MOF 120 in the Presence of GO Sheets 110.

MOF-GO membranes 100 were prepared according to the following procedure: (1) 250 mL of an aqueous graphene oxide dispersion were added to a 1 L reactor. (2) 200 mL of water were added to the 1 L reactor to produce a diluted graphene oxide dispersion. (3) 1.51 g (6.26 mmol) of Cu(II) nitrate trihydrate were added to the diluted graphene oxide dispersion contained in the 1 L reactor. (4) 654.5 mg of H₃BTC (3.11 mmol trimesic acid) dissolved in 57.5 mL of ethanol (EtOH) were subsequently added to produce a Cu—H₃BTC/GO slurry. (5) The resulting Cu—H₃BTC/GO slurry was stirred at 80 °C for a duration of 24 hours. (6) The Cu—H₃BTC/GO slurry was then high shear mixed for 10 minutes at 3,000 rpm using a general-purpose head, measuring the viscosity of the slurry after the high shear mixing. (7) The resulting Cu—H₃BTC/GO slurry was coated and/or casted on a support 200.

### Example 5

### Fabrication of MOF-GO Membranes 100 by 1-Step (In-Situ) Procedure Including Synthesis of Co—H₃BTC MOF 120 in the Presence of GO Sheets 110.

MOF-GO membranes 100 were prepared according to the following procedure: (1) 250 mL of an aqueous graphene oxide dispersion were added to a 1 L reactor. (2) 200 mL of water were added to the 1 L reactor to produce a diluted graphene oxide dispersion. (3) 1.56 g (6.26 mmol) of Co(II) acetate tetrahydrate were added to the diluted graphene oxide dispersion contained in the 1 L reactor. (4) 654.5 mg of H₃BTC (3.11 mmol trimesic acid) dissolved in 57.5 mL of ethanol (EtOH) were subsequently added to produce a Co—H₃BTC/GO slurry. (5) The resulting Co—H₃BTC/GO slurry was stirred at 80 °C for a duration of 24 hours. (6) The Co—H₃BTC/GO slurry was then high shear mixed for 10 minutes at 3,000 rpm using a general-purpose head, measuring the viscosity of the slurry after the high shear mixing. (7) The resulting Co—H₃BTC/GO slurry was coated and/or casted on a support 200.

### Example 6

Fabrication of MOF-GO Membranes 100 by a 2-Step Procedure Including (a) Synthesis of Cu—H₃BTC MOF 120 and (b) Incorporation of Synthesized Cu—H₃BTC MOFs into GO Sheets 110.

MOF-GO membranes 100 were prepared according to the following procedure: (1) a Cu—H₃BTC MOF 120 was first synthesized (without presence of GO sheets 110). The synthesis of the Cu—H₃BTC MOF 120 was carried out according to a hydrothermal experimental procedure described in Example 10. (2) The Cu—H₃BTC MOF 120 was then incorporated into an aqueous graphene oxide dispersion including graphene oxide sheet 110. Given that Cu—H₃BTC MOF 120 is not water-soluble, incorporation and/or intercalation of Cu—H₃BTC MOF 120 into the graphene oxide dispersion was facilitated by high shear mixing (HSM) at 3000 rpm using a general dispersing head. The ratio of Cu—H₃BTC MOF 120 to GO sheets 110 (Cu—H₃BTC MOF:GO sheets) was kept at 1:4 (by dry mass). (3) After 10 minutes of high shear mixing at room temperature, a Cu—H₃BTC/GO slurry was generated. (4) The Cu—H₃BTC/GO slurry was subsequently coated and/or casted on a support 200 cast. (5) An aliquot of the Cu—H₃BTC/GO slurry fabricated at step (3) above was heated under mechanical stirring for 6 hours at 70 °C with the purpose of enhancing intercalation of the Cu—H₃BTC MOF 120 prior to the final casting process. (6) The heated Cu—H₃BTC/GO slurry was also coated and/or casted on a support 200.

### Example 7

Fabrication of MOF-GO Membranes 100 by a 2-Step Procedure Including (a) Synthesis of Cu—H₃BTC MOF, (b) Incorporation of Synthesized Cu—H₃BTC MOFs into GO Sheets 110 and Subsequent Casting Via Vacuum Cast

MOF-GO membranes 100 were prepared according to the following procedure: (1) a Cu—H₃BTC MOF 120 was first synthesized (without presence of GO sheets 110). The synthesis of the Cu—H₃BTC MOF 120 was carried out according to a hydrothermal experimental procedure described in Example 10. (2) Grinding the synthesized Cu—H₃BTC MOF 120 into a fine powder using a mortar and pestle. (3) Mixing the fine powder Cu—H₃BTC MOF 120 into an aqueous graphene oxide dispersion including graphene oxide sheets 110 to produce a Cu—H₃BTC/GO slurry. Given that Cu—H₃BTC MOF 120 is not water-soluble, incorporation and/or intercalation of Cu—H₃BTC MOF 120 into the graphene oxide dispersion was facilitated by high shear mixing (HSM) or magnetic stirring according to the conditions and/or parameters summarized in Table 1. (4) The resulting Cu—H₃BTC/GO slurry coated and/or casted into the desired shape and/or onto a support 200. Casting of the Cu—H₃BTC/GO slurry was performed via vacuum casting. That is, the Cu—H₃BTC/GO slurry was drawn into a mold using a vacuum.

TABLE 1
Reaction parameters for incorporation and/or
intercalation of Cu—H₃BTC MOF 120 into graphene
oxide dispersion according to an embodiment.

| | GO | MOF | |
|---|---|---|---|
| | loading | loading | |
| Protocol | (mg) | (mg) | Mixing |
| 1 | 80 | 40 | HSM (emulsion head, 5000 rpm, 10 mins) |
| 2 | 80 | 8 | HSM(emulsion head, 5000 rpm, 10 mins) |
| 3 | 80 | 8 | Magnetic Stirring (800 rpm, 10 mins) |

### Example 8

Fabrication of MOF-GO Membranes 100 by a 1-Step (In-Situ) Procedure Including Synthesis of MOF 120 Using Metal Acetates, and H₃BTC Organic Linker Pre-Dissolved in Alcohol in a Separate Container (e.g., Outside of the Vessel and/or Reactor).

MOF-GO membranes 100 were prepared according to the following procedure: (1) Dissolving H₃BTC in ethanol in a round bottom flask (RBF) at 200 rpm at a temperature of 60 °C or 80 °C, heating the RBF using an immersed oil bath and stirring using a magnetic stirrer. To evaluate the impact of the dissolution of H₃BTC linker in ethanol on the characteristics of the resulting MOF-GO membrane, two formulations having different amounts of water (e.g., concentrated MOF-GO membrane formulation or dilute MOF-GO membrane formulation) were prepared, as described in Tables 2 and 3. (2) Preparing a graphene oxide dispersion containing 1 wt. % GO sheets 110 in water (concentrated and/or dilute formulation) in a vessel and/or reactor while agitating the contents of the vessel and/or reactor at about 200 rpm. (3) Adding a metal acetate (Co (II) acetate tetrahydrate) to the graphene oxide dispersion in the vessel and/or reactor and increase agitation speed to 400 rpm. (4) Adding the H₃BTC in ethanol dissolved using the RBF in step 1 to the vessel and/or reactor once the H₃BTC is completely dissolved. (5) Agitating the vessel and/or reactor resulting mixture for 10 min at 400 rpm, then reducing the speed of agitation to 300 rpm. (6) Agitating the resulting mixture for 24 hours at about 80 °C. (7) Cooling the mixture to 30 C. (8) Exposing the resulting mixture to high shear mix.

TABLE 2
Concentration of reagents used to fabricate concentrated MOF-GO
membrane formulation according to Examples 8 and 9.

| Material | Loading (%) | Mass (g) |
|---|---|---|
| Graphene Oxide | 0.280 | 392.6 |
| Alcohol (EtOH or IPA) | 15.284 | 86.6 |
| H₃BTC | 0.174 | 1.03 |
| Co(II) acetate tetrahydrate | 0.428 | 2.4 |
| water | 13.942 | 78.2 |

TABLE 3
Concentration of reagents used to fabricate diluted MOF-GO
membrane formulation according to Examples 8 and 9.

| Material | Loading (%) | Mass (g) |
|---|---|---|
| Graphene Oxide | 0.196 | 274.8 |
| Alcohol (EtOH or IPA) | 10.717 | 63.3 |
| H₃BTC | 0.122 | 0.72 |
| Co(II) acetate tetrahydrate | 0.300 | 1.71 |
| water | 39.238 | 220.3 |

### Example 9

### Fabrication of MOF-GO Membranes 100 by a 1-Step (In-Situ) Procedure Including Synthesis of MOF 120 at a Reduced Temperature of 60 °C Using of Metal Acetates, and H₃BTC Organic Linker Pre-Dissolved in Alcohol.

MOF-GO membranes 100 were prepared according to the following procedure: (1) Dissolving H₃BTC organic linker in ethanol by heating in a vessel and/or reactor at 200 rpm and 60 °C according to the concentrations shown in Table 2 and 3. (2) Preparing a graphene oxide dispersion containing 1 wt. % GO sheets 110 in water (concentrated and/or dilute) using a beaker with an overhead stirrer, stirring at 200 rpm for 30 minutes. (3) Adding the graphene oxide dispersion of step 2 to the H₃BTC in ethanol disposed in the vessel and/or reactor once the H₃BTC organic linker is dissolved well. (4) Increasing the stirring speed to 400 rpm. (5) Adding a metal acetate to the graphene oxide dispersion containing the H₃BTC organic linker and continue to stir for 10 minutes. (6) Reducing the stirring speed to 300 rpm. (7) Agitating the resulting mixture for 24 hours at about 60 °C. (8) Exposing the resulting mixture to high shear mix.

### Examples 10-12

### Synthesis of MOFs 120

### Example 10

A Cu—H₃BTC MOF 120 was prepared according to a hydrothermal synthesis procedure including: (1) Dissolving 0.97 g of Cu(NO₃)₂·3H₂O in 12 mL of deionized water. (2) Dissolving in a separate vessel and/or container 0.42 g of H₃BTC in 12 mL of ethanol. (3) Sonicating the H₃BTC for several minutes until solubilizing it. (4) Mixing the Cu(NO₃)₂·3H₂O solution in step (1) with the H₃BTC solution in step (2) using a Teflon-lined stainless-steel reactor, which is subsequently sealed. (5) Heating the reactor to 110 °C in an oven for 24 hours and then allowing to cool naturally to room temperature. (6) Collecting a light blue solid product from the reactor. (7) Washing the resulting light blue solid with ethanol and chloroform three times each. (8) Placing the resulting solid under high vacuum at 110 °C, causing it to turn dark blue.

### Example 11

A Cu—H₃BTC MOF 120 was prepared according to a hydrothermal synthesis procedure including: (1) Dissolving 0.97 g of Cu(NO₃)₂·3H₂O in deionized 12 mL of water. (2) Dissolving in a separate vessel and/or container, 42 g of H₃BTC in 12 mL of ethanol. (3) Sonicating the H₃BTC for several minutes until solubilizing it. (4) Mixing the Cu(NO₃)₂·3H₂O solution in step (1) with the H₃BTC solution in step (2) using a 100 mL round bottom flask, which is subsequently sealed with a rubber septum. (5) Heating the flask in an oil bath at 80 °C for 24 hours. (6) Collecting a light blue solid product from the flask. (7) Washing the resulting light blue solid with ethanol and chloroform three times each. (8) Placing the resulting solid under high vacuum at 110 °C, causing it to turn dark blue.

### Example 12

A Cu—H₃BTC MOF 120 was prepared according to a hydrothermal synthesis procedure including: (1) Dissolving 0.97 g of Cu(NO₃)₂·3H₂O organic linker in deionized 12 mL of water. (2) Dissolving in a separate vessel and/or container, 42 g of H₃BTC in 12 mL of ethanol. (3) Sonicating the H₃BTC for several minutes until solubilizing it. (4) Mixing the Cu(NO₃)₂·3H₂O solution in step (1) with the H₃BTC solution in step (2) using a 100 mL round bottom flask, which is subsequently sealed with a rubber septum. (5) Heating the flask in an oil bath at 110 °C for 24 hours. (6) Collecting a light blue solid product from the flask. (7) Washing the resulting light blue solid with ethanol and chloroform three times each. (8) Placing the resulting solid under high vacuum at 110 °C, causing it to turn dark blue.

### Example 13

### Pre-Processing of GO Sheets 110

A Teflon-lined stainless-steel reactor was filled with 28 mL of a graphene oxide dispersion. The reactor was then sealed and heated in an oven at 110 °C for 24 hours. After the heating period, the reactor was allowed to cool naturally to room temperature.

### Example 14

Fabrication of MOF-GO Membranes 100 by Mixing MOFs Synthesized as Described in Examples 10-12 with GO Sheets 110.

MOF-GO membranes 100 were prepared according to the following procedure: (1) Synthesizing Cu—H₃BTC MOF(s) 120 separately as described in Examples 10-12. (2) Mixing the H₃BTC MOF(s) 120 from step (1) with pre-processed GO sheets 110 obtained as described in Example 13. (3) Stirring the resulting mixture at a stirring speed ranging from about 200 rpm to about 1000 rpm using magnetic stirring. (4) Optionally, using high shear mixing at a stirring rate from about 1000 to about 5000 rpm. The high shear mixing stirring can be performed at room temperature, or at any temperature between about 30 °C to about 150 °C. (4) Casting the resulting mixture into a desired shape or onto a support 200 to form a MOF-GO membrane 100.

### Example 15

Fabrication of MOF-GO Membranes with Water Concentrations.

MOF-GO membranes 100 were prepared using different amounts and/or quantities of water (e.g., diluted and concentrated slurries) according to the following procedure: (1) Adding isopropanol, water, and H₃BTC to a reactor according to the specific quantities described in Table 4 or Table 5, heating the reactor to a temperature of 60 °C. (2) Mixing Co (II) acetate tetrahydrate and water in a jar at room temperature until the Cobalt salt is fully dissolved. (3) Incorporating a graphene oxide dispersion to the reactor described in step (1) while the reactor is held at a temperature of 60 °C under constant stirring at 300 rpm. The temperature of the mixture in the reactor is then allowed to comeback to 60 °C before proceeding with the next step. (4) incorporating the Co (II) acetate tetrahydrate solution from step (2) in the reactor using a syringe pump connected to a pipe with an outlet positioned under the surface of the reacting mixture adjacent to the blades of the mechanical stirrer. An initial 13% volume of the Co (II) acetate tetrahydrate solution was flown into the reactor via the outlet by incrementally dosing discrete volumes of the Co solution during 60 min in 10 min increments. For example, 0-10 mins: 5.787 μL, 0.579 μL/min, 11-20 mins, 40.51 μL, 4.051 μL/min, 21-30 mins, 110.0 μL, 10.99 μL/min, 31-40 mins, 214.1 μL, 21.41 μL/min, 41-50 mins, 353.0 μL, 35.30 μL/min, and 51-60 mins, 526.6 μL, 52.6 6 uL/min. (5) Keeping the reactor at 60 °C for 1 hour before incorporating the remaining volume of the Co (II) acetate tetrahydrate solution at a constant flow rate for 30 min. (6) Allowing the mixture to react for 24 hours at 60 °C at 300 rpm. (7) Cooling the reactor to 25 °C and collecting the produced slurry. (8) Exposing the resulting slurry to high shear mixer with an emulsion head for 30 min, and (9) filtering the resulting slurry using a 100 μm mesh sock filter.

TABLE 4
MOF-GO membranes fabricated according to diluted slurry.

| Material | Loading (%) | Mass (g) |
|---|---|---|
| Graphene Oxide | 0.196 | 211.89 |
| Co(II) acetate tetrahydrate | 0.3 | 1.22 |
| Water for H₃BTC | 34.09 | 136.36 |
| H₃BTC | 0.122 | 0.51 |
| Water for Co(II) acetate | 1.685 | 6.74 |
| tetrahydrate | | |
| Isopropyl Alcohol | 10.717 | 43.3 |

TABLE 5
MOF-GO membranes fabricated according to concentrated slurry.

| Material | Loading (%) | Mass (g) |
|---|---|---|
| Graphene Oxide | 0.28 | 302.7 |
| Co(II) acetate tetrahydrate | 0.428 | 1.75 |
| Water for H₃BTC | 5.9 | 23.6 |
| H₃BTC | 0.174 | 0.73 |
| Water for Co(II) acetate | 2.413 | 9.65 |
| tetrahydrate | | |
| Isopropyl Alcohol | 15.284 | 61.75 |

1. A filtration apparatus, comprising:
a support substrate; and
a metal organic framework modified graphene oxide (MOF-GO) membrane disposed on the support substrate, the MOF-GO membrane including:
a plurality of graphene oxide sheets; and
a metal organic framework intercalated between the plurality of graphene oxide sheets,
wherein:
the MOF-GO membrane has a total solids rejection rate of at least about 50% and a flux of at least about 4 gallons per square foot per day (GFD) in flowing a weak black liquor solution at a predetermined temperature and pressure.

2. The filtration apparatus of claim 1, wherein the weak black liquor solution comprises sodium sulfate, sodium carbonate, sodium hydrosulfide, sodium thiosulfate, sodium hydroxide, tall oils, carbohydrates, lignin, cellulose, hemicellulose, or a combination thereof.

3. The filtration apparatus of claim 1, wherein the weak black liquor solution contains between about 2 and 20 wt. % total dissolved solids.

4. The filtration apparatus of claim 1, wherein the predetermined temperature is at least about 50 °C.

5. The filtration apparatus of claim 1, wherein a mass ratio of the metal organic framework to the plurality of graphene oxide sheets is at least from about 1:1 to no more than about 1:4.

6. The filtration apparatus of claim 1, wherein the metal organic framework includes:
a coordinated metal; and
an organic linker covalently bound to the coordinated metal.

7. The filtration apparatus of claim 6, wherein the coordinated metal is selected from at least one of Cu, Co, or Ni.

8. The filtration apparatus of claim 6, wherein the organic linker is selected from at least one of hexahydroxytriphenylene, 1,3,5-benzenetricarboxylic acid or a derivative thereof.

9. The filtration apparatus of claim 6, wherein the metal organic framework includes Co—H₃BTC.

10. A method for fabricating a filtration apparatus, comprising:
preparing a graphene oxide dispersion, the graphene oxide dispersion including a predetermined concentration of graphene oxide sheets;
mixing a metal-containing reagent to the graphene oxide dispersion;
mixing an organic linker to the graphene oxide dispersion;
after mixing the metal containing reagent and the organic linker, stirring the graphene oxide dispersion at a predetermined temperature for a period of time to produce a metal organic framework graphene oxide (MOF-GO) slurry; and
coating the MOF-GO slurry on a support substrate.

11. The method of claim 10, wherein the metal-containing reagent is a coordinated metal selected from at least one of Cu, Co, or Ni.

12. The method of claim 10, wherein the organic linker is selected from at least one of hexahydroxytriphenylene, 1,3,5-benzenetricarboxylic acid or a derivative thereof.

13. The method of claim 10, wherein the MOF-GO slurry includes Co—H₃BTC.

14. The method of claim 10, wherein the predetermined temperature is at least about 60 °C and the less than about 90 °C.

15. The method of claim 10, wherein mixing an organic linker to the graphene oxide dispersion further includes:
mixing the organic linker with a solvent at a dissolving temperature;
heating the solvent with the organic linker to a solubilization temperature to produce an organic linker solution; and
adding the organic linker solution to the graphene oxide dispersion.

16. The method of claim 14, wherein the organic linker is 1,3,5-benzenetricarboxylic acid, the solvent is one of isopropyl alcohol or ethanol, and the dissolving temperature is about 60 °C.

17. The method of claim 10, wherein the predetermined concentration of graphene oxide sheets is at least about 0.2 wt. % and no more than about 0.4 wt. %.

18. The method of claim 10, wherein the support substrate includes at least one of polystyrene, polyethylene, polyethylene oxide, polyethersulfone (PES), o polytetrafluoroethylene.
